(19) United States
(12) Patent Application Publication
(10) Pub. No.: US 2018/0265609 A1
(43) Pub. Date: Sep. 20, 2018

(54) POLYMERIZABLE LIQUID CRYSTAL COMPOSITION, AND OPTICALLY ANISOTROPIC BODY, PHASE DIFFERENCE FILM, ANTIREFLECTION FILM, AND LIQUID CRYSTAL DISPLAY ELEMENT PRODUCED USING COMPOSITION

(71) Applicant: DIC Corporation, Tokyo (JP)

(72) Inventors: Kouichi Endo, Kita-adachi-gun (JP); Mika Yamamoto, Kita-adachi-gun (JP); Kazuaki Hatsusaka, Kita-adachi-gun (JP)

(73) Assignee: DIC Corporation, Tokyo (JP)

(21) Appl. No.: 15/542,515

(22) PCT Filed: Jan. 7, 2016
(86) PCT No.: PCT/JP2016/050321

§ 371 Date: Jul. 10, 2017

(30) Foreign Application Priority Data
Jan. 13, 2015 (JP) 2015-004146

(51) Int. Cl. C08F 22/20; C08K 5/06; C08K 5/37; C08K 5/435; C08K 5/05; G02B 5/30; G02B 1/111

(52) U.S. Cl. CPC C08F 22/20; C08K 5/06; C08K 5/37; G02B 1/111; C08K 5/05; G02B 5/3016; C08K 5/435

(57) ABSTRACT

The present invention provides a polymerizable liquid crystal composition including a specific polymerizable compound and a fluorosurfactant having a pentaerythritol skeleton or a dipentaerythritol skeleton in the molecule. In addition, an optically anisotropic body, a phase difference film, an antireflection film, and a liquid crystal display device, which are produced by using the polymerizable liquid crystal composition according to the present invention, are provided. The present invention is useful because three properties, that is, leveling properties of the surface of an optically anisotropic body, offset to a base material, and alignment properties of a liquid crystal can be improved at the same time in the case where the optically anisotropic body is produced by photopolymerizing the polymerizable liquid crystal composition.

### TECHNICAL FIELD

The present invention relates to a polymerizable liquid crystal composition that is a useful constituent member of an optically anisotropic body used for liquid crystal devices, displays, optical parts, colorants, security markings, laser emission members, and optically compensating liquid crystal displays and the like, and to an optically anisotropic body, a phase difference film, an antireflection film, and a liquid crystal display element composed of the composition.

### BACKGROUND ART

A polymerizable liquid crystal composition is a useful constituent member of an optically anisotropic body. The optically anisotropic body is used for, for example, a phase difference film and an antireflection film, which are applied to various liquid crystal displays. The optically anisotropic body containing a liquid crystal substance as a constituent component is produced by coating a substrate with a polymerizable liquid crystal composition and curing the polymerizable liquid crystal composition, in an aligned state, by performing heating or radiating active energy rays. In order to obtain stable uniform optical characteristics, it is necessary that the uniformly aligned structure of liquid crystal molecules in the liquid crystal state be semipermanently fixed.

Up to now, polymerizable liquid crystal compositions containing a surfactant so as to improve the applicability to a substrate have been disclosed (PTL 1 and 2). Also, roll-to-roll coating of a film base material has been performed as an efficient and economical coating method in recent years. However, in this method, a coated film surface and the base material come into contact with each other due to take-up of the film base material after coating and, as a result, there is a problem in that defective appearance of a coating film or a base material frequently occurs because of transfer of a surfactant in the coating film due to the contact. According to the methods in the above-described literature, applicability to the substrate is improved and occurrence of variations in film thickness can be reduced, even though there is no description of the defective appearance (offset properties) problem resulting from the contact between the coated film surface after the coating and the base material and no description of a measure thereto.

### CITATION LIST

### Patent Literature

PTL 1: Japanese Unexamined Patent Application Publication No. 08-231958
PTL 2: Japanese Unexamined Patent Application Publication No. 2000-105315

### SUMMARY OF INVENTION

### Technical Problem

An issue to be addressed by the present invention is the provision of a polymerizable liquid crystal composition that can solve the above-described problem by improving two characteristics of leveling properties of the surface of an optically anisotropic body and offset properties at the same time while excellent alignment properties of the optically anisotropic body is maintained in the case where the optically anisotropic body is produced by photopolymerizing the polymerizable liquid crystal composition.

### Solution to Problem

Regarding the present invention, in order to solve the above-described problem, a polymerizable liquid crystal composition has attracted a great deal of attention and repeated research has been performed. As a result, the present invention was realized.

That is, the present invention provides a polymerizable liquid crystal composition including at least one polymerizable compound denoted by general formula (I)

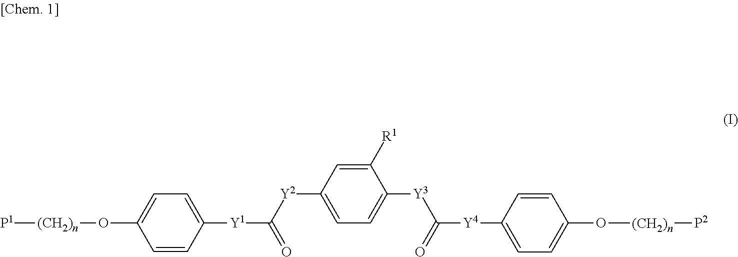

(n represents an integer of 1 to 10, each of P¹ and P² represents an acryloyl group, a methacryloyl group, a vinyl ether group, an aliphatic epoxy group, or an alicyclic epoxy group, each of Y¹, Y², Y³, and Y⁴ represents a single bond, —O—, —CH₂—, —CH₂CH₂—, —OCH₂CH₂-, or —CH₂CH₂O—, and R¹ represents a hydrogen atom, a methyl group, an ethyl group, a methoxy group, an ethoxy group, or —COO—CH₂—C₆H₅) and a fluorosurfactant that is a compound having a pentaerythritol skeleton or a dipentaerythritol skeleton.

In addition, an optically anisotropic body including the polymerizable liquid crystal composition according to the present invention is provided.

### Advantageous Effects of Invention

An optically anisotropic body having excellent surface smoothness and exhibiting low offset properties with respect to a liquid crystal coating film surface can be produced by using the polymerizable liquid crystal composition according to the present invention while maintaining excellent alignment properties of the optically anisotropic body.

### DESCRIPTION OF EMBODIMENTS

The most favorable form of a polymerizable liquid crystal composition according to the present invention will be described below. In the present invention, “liquid crystal” with respect to the polymerizable liquid crystal composition refers to liquid crystallinity being exhibited after the polymerizable liquid crystal composition is applied to the base material and drying is performed. In this regard, the polymerizable liquid crystal composition can be made into a polymer (made into a film) by being subjected to polymerization treatment in which irradiation with light, e.g., ultraviolet rays, or heating is performed.

(Difunctional Polymerizable Compound)

The polymerizable liquid crystal composition according to the present invention contains at least one difunctional polymerizable compound denoted by general formula (I),

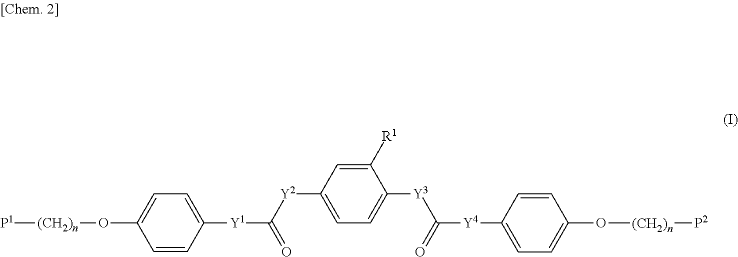

and preferably contains at least two types. In this regard, n represents an integer of 1 to 10, preferably n represents an integer of 1 to 9, and further preferably n represents an integer of 2 to 8, each of Y¹, Y², Y³, and Y⁴ represents a single bond, —O—, —CH₂—, —CH₂CH₂—, —OCH₂CH₂—, or —CH₂CH₂O—, and preferably a single bond, —O—, —OCH₂CH₂—, or —CH₂CH₂O—, R¹ represents a hydrogen atom, a methyl group, an ethyl group, a methoxy group, an ethoxy group, or —COO—CH₂—C₆H₅, and preferably a hydrogen atom, a methyl group, or —COO—CH₂—CH₆H₅, and each of P¹ and P represents an acryloyl group, a methacryloyl group, a vinyl ether group, an aliphatic epoxy group, or an alicyclic epoxy group, preferably an acryloyl group, a methacryloyl group, an aliphatic epoxy group, or an alicyclic epoxy group, and particularly preferably an acryloyl group or a methacryloyl group. Specifically, it is particularly preferable that the compounds denoted by formula (I-1-1) to formula (I-1-7) described below be used.

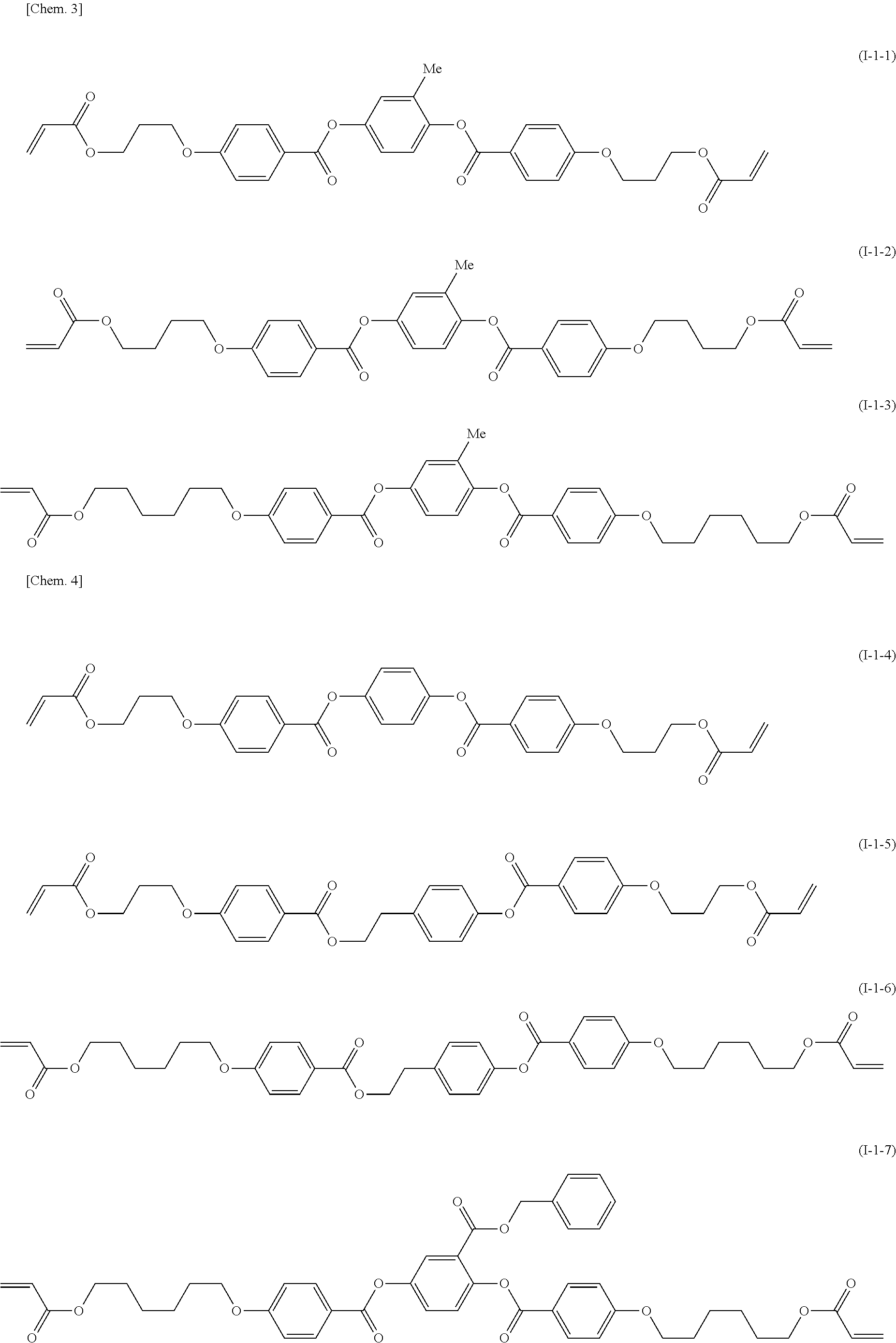

According to the present invention, the polymerizable liquid crystal composition containing at least one of these difunctional polymerizable compounds is preferable because the heat resistance and the moist-heat resistance of a cured coating film are improved.

Regarding the content of the difunctional polymerizable compound denoted by general formula (I) in the case where a chiral compound described later is included, the content is preferably 40 to 80 percent by mass of the total amount of the polymerizable compound and chiral compound used, the content is more preferably 45 to 75 percent by mass, and the content is particularly preferably 50 to 70 percent by mass.

Meanwhile, in the case where a chiral compound is not used, the content of the difunctional polymerizable compound denoted by general formula (I) is preferably 10 to 100 percent by mass of the total amount of polymerizable compounds used, the content is more preferably 15 to 100 percent by mass, and the content is particularly preferably 20 to 100 percent by mass.

In addition, the polymerizable liquid crystal composition according to the present invention can contain a difunctional polymerizable compound other than the difunctional polymerizable compound denoted by general formula (I) described above. Specifically, a compound that is used is a compound denoted by general formula (I-2)

[Chem. 5]

P-(Sp)ₘ-MG-(Sp)ₘ-P (I-2)

(in the formula, P represents a polymerizable functional group,
Sp represents a spacer group having a carbon atom number of 0 to 18,
each m represents 0 or 1, and
MG represents a mesogenic group or a mesogenic support group, where the compound denoted by general formula (I) described above is excluded).

More specifically, a compound that is used is a compound denoted by general formula (I-2), in which Sp represents an alkylene group (the alkylene group may include a substituent composed of at least one halogen atom or CN, and a CH₂ group or each of at least two CH₂ groups that are not adjacent to each other in the alkylene group may be substituted with —O—, —S—, —NH—, —N(CH₃)—, —CO—, —COO—, —OCO—, —OCOO—, —SCO—, —COS—, or —C≡C— in the form in which oxygen atoms are not directly bonded to each other) and MG is denoted by general formula (I-2-b)

[Chem. 6]

—Z0-(A1-Z1)ₙ-A2-Z2-A3-Z3- (I-2-b)

(in the formula, each of A1, A2, and A3 represents a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group and may have at least one substituent composed of F, Cl, CF₃, OCF₃, a CN group, an alkyl group having a carbon atom number of 1 to 8, an alkoxy group, an alkanoyl group, an alkanoyloxy group, an alkenyl group having a carbon atom number of 2 to 8, an alkenyloxy group, an alkenoyl group, or an alkenoyloxy group, each of Z0, Z1, Z2, and Z3 represents —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group that has a carbon atom number of 2 to 10 and may have a halogen atom, or a single bond, and n represents 0, 1, or 2).

Regarding the polymerizable functional group, a vinyl group, a vinyl ether group, an acryl group, a (meth)acryl group, a glycidyl group, an oxetanyl group, a maleimide group, and a thiol group are preferable. From the viewpoint of productivity, a vinyl ether group, an acryl group, a (meth)acryl group, and a glycidyl group are further preferable, and an acryl group and a (meth)acryl group are particularly preferable.

Examples of the compounds are shown below but the compounds are not limited to these examples.

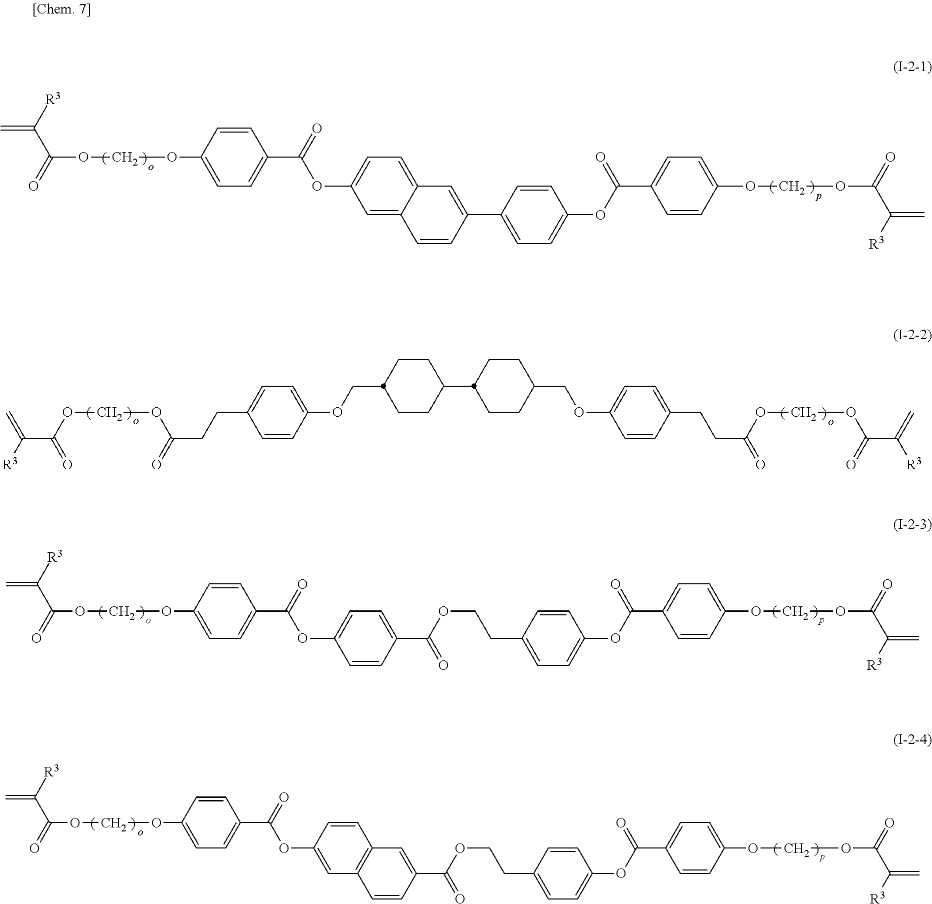

(in the formula, each of o and p represents an integer of 1 to 18, R³ represents a hydrogen atom, a halogen atom, an alkoxy group having a carbon number of 1 to 6, or a cyano group, and in the case where these groups are alkoxy groups having a carbon number of 1 to 6, all of the alkoxy groups may be unsubstituted or the alkoxy groups may include a substituent composed of at least one halogen atom) These compounds can be used alone, or at least two types can be used in combination.

Regarding the content of the difunctional polymerizable compound other than the difunctional polymerizable compound denoted by general formula (I) described above, the content is preferably 0 to 10 percent by mass of the total amount of the polymerizable compound and chiral compound used, the content is more preferably 0 to 8 percent by mass, and the content is particularly preferably 0 to 5 percent by mass.

Meanwhile, in the case where a chiral compound is not used, the content of the difunctional polymerizable compound other than the difunctional polymerizable compound denoted by general formula (I) described above is preferably 0 to 10 percent by mass of the total amount of polymerizable compounds used, the content is more preferably 0 to 8 percent by mass, and the content is particularly preferably 0 to 5 percent by mass.

(Monofunctional Polymerizable Compound)

In addition, the polymerizable liquid crystal composition according to the present invention may contain a monofunctional polymerizable compound having one polymerizable functional group in the molecule. Regarding the monofunctional polymerizable compound, at least one monofunctional polymerizable compound selected from the group consisting of compounds denoted by general formula (II-1)

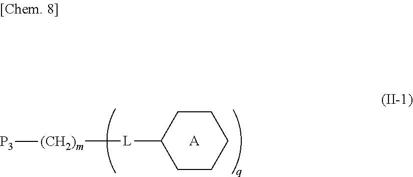

can be used. In general formula (II-1), m represents an integer of 0 to 10, preferably an integer of 0 to 8, and further preferably an integer of 0 to 6, q represents 2 or 3, each L represents a single bond, —O—, —CO—, —COO—, —OCO—, or —N═N—, and preferably a single bond, —O—, —COO—, or —N═N—, each A represents a 1,4-phenylene group, a 1,6-naphthalene group, or a 1,4-cyclohexylene group, and each of the 1,4-phenylene group, the 1,6-naphthalene group, and the 1,4-cyclohexylene group, that is A, may include a substituent composed of a fluorine atom, a chlorine atom, a CF₃ group, a OCF₃ group, a cyano group, an alkyl group having a carbon atom number of 1 to 8, an alkoxy group, an alkanoyl group, or an alkanoyloxy group.

The compound denoted by general formula (II-1) is preferably a compound denoted by general formula (II-1-a) described below.

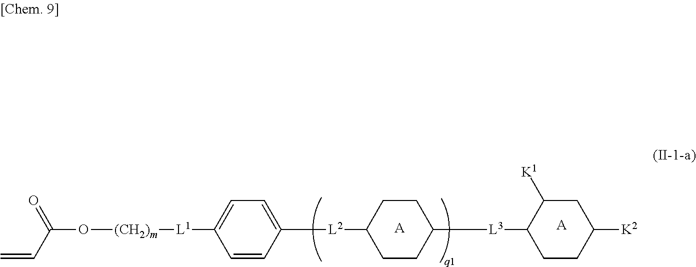

In general formula (II-1-a), m represents an integer of 0 to 10, preferably an integer of 0 to 8, and further preferably an integer of 0 to 6, q¹ represents 0 or 1, each of L¹, L², and L³ represents a single bond, —O—, —CO—, —COO—, —OCO—, or —N═N—, and preferably a single bond, —O—, —COO—, or —N═N—, each A represents a 1,4-phenylene group, a 1,6-naphthalene group, or a 1,4-cyclohexylene group and preferably a 1,4-phenylene group, a 1,6-naphthalene group, or a 1,4-cyclohexyl group, and each of K¹ and K² represents a hydrogen atom, a fluorine atom, a chlorine atom, a CF₃ group, a OCF₃ group, a cyano group, an alkyl group having a carbon atom number of 1 to 8, an alkoxy group, an alkanoyl group, or an alkanoyloxy group and preferably a hydrogen atom, a cyano group, an alkyl group having a carbon atom number of 1 to 8, or an alkoxy group.

More specifically, compounds denoted by formula (II-1-1) to formula (II-1-7) can be used.

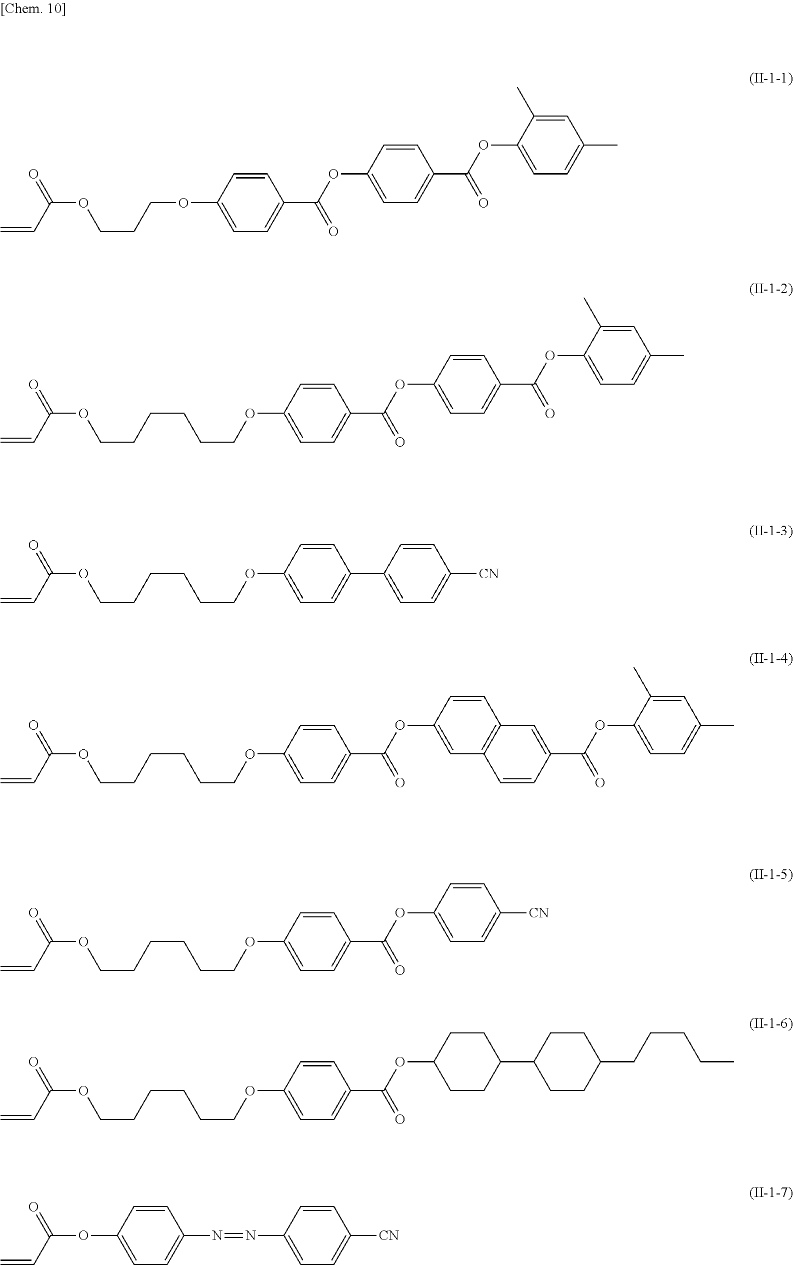

In particular, it is preferable that at least one of or both the compound denoted by general formula (II-1-1) and the compound denoted by general formula (II-1-2) be used because an optically anisotropic body having excellent alignment properties may be obtained. Also, it is preferable that the compound denoted by general formula (II-1-3) be included because an optically anisotropic body having excellent alignment properties may be obtained.

The content of the monofunctional polymerizable compound having one polymerizable functional group in the molecule is preferably 10 to 60 percent by mass of the total amount of the polymerizable compound and chiral compound used, more preferably 15 to 50 percent by mass, and particularly preferably 20 to 45 percent by mass.

Meanwhile, in the case where a chiral compound is not used, the content of the monofunctional polymerizable compound having one polymerizable functional group in the molecule is preferably 0 to 90 percent by mass of the total amount of the polymerizable compound used, more preferably 0 to 85 percent by mass, and particularly preferably 0 to 80 percent by mass.

The content of the compound denoted by general formula (II-1) is preferably 10 to 60 percent by mass of the total amount of the polymerizable compound and chiral compound used, more preferably 15 to 55 percent by mass, and particularly preferably 20 to 45 percent by mass.

Meanwhile, in the case where a chiral compound is not used, the content of the compound denoted by general formula (II-1) is preferably 0 to 90 percent by mass of the total amount of the polymerizable compounds used, more preferably 0 to 85 percent by mass, and particularly preferably 0 to 80 percent by mass.

The polymerizable liquid crystal composition according to the present invention can contain a monofunctional polymerizable compound other than the monofunctional polymerizable compound denoted by general formula (II-1) described above. Specifically, a compound that is used is a compound denoted by general formula (II-2)

[Chem. 11]

P-(Sp)ₘ-MG-R¹ (II-2)

(in the formula, P represents a polymerizable functional group,
Sp represents a spacer group having a carbon atom number of 0 to 18,
m represents 0 or 1,
MG represents a mesogenic group or a mesogenic support group, and
R¹ represents a halogen atom, a cyano group, or an alkyl group having a carbon atom number of 1 to 18, the alkyl group may include a substituent composed of at least one halogen atom or CN, and a CH₂ group or each of at least two CH₂ groups that are not adjacent to each other in the alkyl group may be substituted with —O—, —S—, —NH—, —N(CH₃)—, —CO—, —COO—, —OCO—, —OCOO—, —SCO—, —COS—, or —C≡C— in the form in which oxygen atoms are not directly bonded to each other, where the compound denoted by general formula (II-1) described above is excluded).

More specifically, a compound that is used is a compound denoted by general formula (II-2), in which Sp represents an alkylene group, (the alkylene group may include a substituent composed of at least one halogen atom or CN, and a CH₂ group or each of at least two CH₂ groups that are not adjacent to each other in the alkylene group may be substituted with —O—, —S—, —NH—, —N(CH₃)—, —CO—, —COO—, —OCO—, —OCOO—, —SCO—, —COS—, or —C≡C— in the form in which oxygen atoms are not directly bonded to each other) and MG is denoted by general formula (II-2-b)

[Chem. 12]

-Z0-(A1-Z1)ₙ-A2-Z2-A3-Z3- (II-2-b)

(in the formula, each of A1, A2, and A3 represents a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group and may have at least one substituent composed of F, Cl, CF₃, OCF₃, a CN group, an alkyl group having a carbon atom number of 1 to 8, an alkoxy group, an alkanoyl group, an alkanoyloxy group, an alkenyl group having a carbon atom number of 2 to 8, an alkenyloxy group, an alkenoyl group, or an alkenoyloxy group, each of Z0, Z1, Z2, and Z3 represents —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group that has a carbon atom number of 2 to 10 and may have a halogen atom, or a single bond, and n represents 0, 1, or 2).

Regarding the polymerizable functional group, a vinyl group, a vinyl ether group, an acryl group, a (meth)acryl group, a glycidyl group, an oxetanyl group, a maleimide group, and a thiol group are preferable. From the viewpoint of productivity, a vinyl ether group, an acryl group, a (meth)acryl group, and a glycidyl group are further preferable, and an acryl group and a (meth)acryl group are particularly preferable.

Examples of the compounds are shown below but the compounds are not limited to these examples.

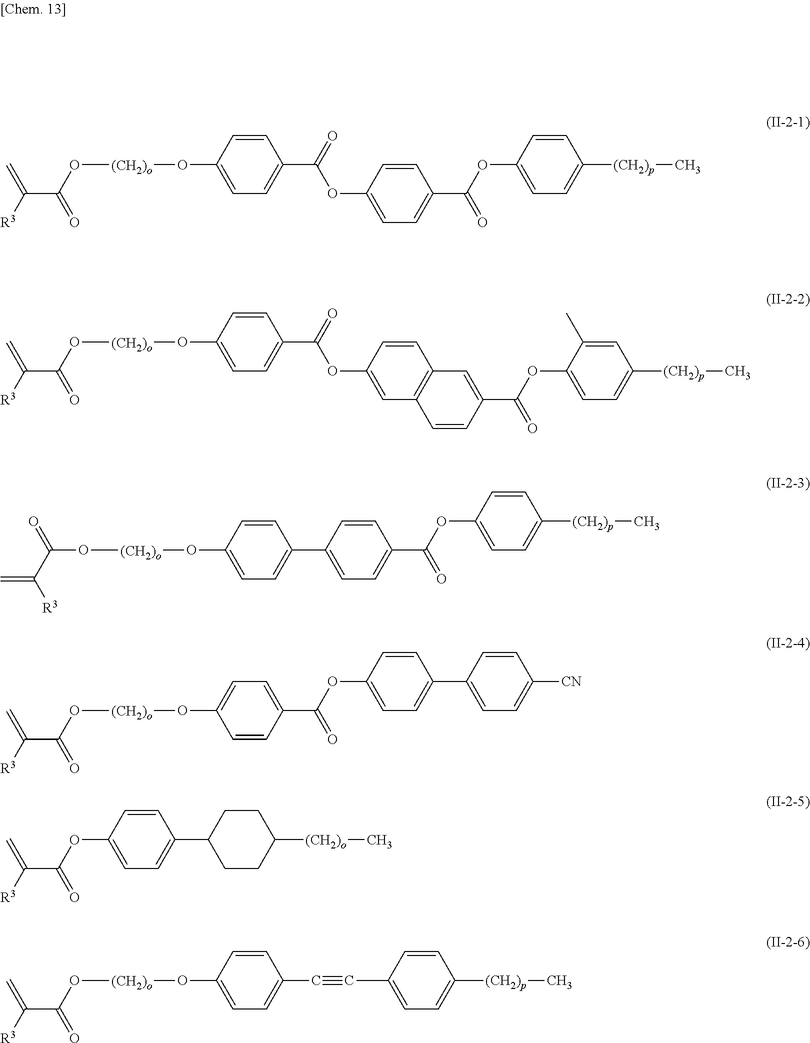

(in the formula, each of o and p represents an integer of 1 to 18, R³ represents a hydrogen atom, a halogen atom, an alkoxy group having a carbon number of 1 to 6, or a cyano group, and in the case where these groups are alkoxy groups having a carbon number of 1 to 6, all of the alkoxy groups may include no substituent or the alkoxy groups may include a substituent composed of at least one halogen atom) These compounds can be used alone, or at least two types can be used in combination.

Regarding the content of the monofunctional polymerizable compound other than the compound denoted by general formula (II-2) described above, the content is preferably 0 to 10 percent by mass of the total amount of the polymerizable compound and chiral compound used, the content is more preferably 0 to 8 percent by mass, and the content is particularly preferably 0 to 5 percent by mass.

Meanwhile, in the case where a chiral compound is not used, the content of the monofunctional polymerizable compound other than the compound denoted by general formula (II-2) described above is preferably 0 to 10 percent by mass of the total amount of polymerizable compounds used, the content is more preferably 0 to 8 percent by mass, and the content is particularly preferably 0 to 5 percent by mass.

Regarding the total content of the monofunctional polymerizable compound and the difunctional polymerizable compound in the polymerizable liquid crystal composition according to the present invention, the content is preferably 20 to 100 percent by mass of the total amount of polymerizable compounds used, the content is more preferably 40 to 100 percent by mass, and the content is particularly preferably 60 to 100 percent by mass.

(Chiral Compound)

A chiral compound may be mixed into the polymerizable liquid crystal composition according to the present invention for the purpose of obtaining a chiral nematic phase. Among chiral compounds, a compound having a polymerizable functional group in the molecule is particularly preferable. Regarding the polymerizable functional group in the chiral compound, an acryloyloxy group is particularly preferable. The amount of the chiral compound mixed has to be adjusted appropriately in accordance with the helical twisting power of the compound. The content is preferably 3 to 400% relative to the polymerizable compound used, the content is more preferably 3 to 300%, and the content is particularly preferably 3 to 200%.

Specific examples of chiral compounds can include compounds denoted by formulae (1-1) to (1-9).

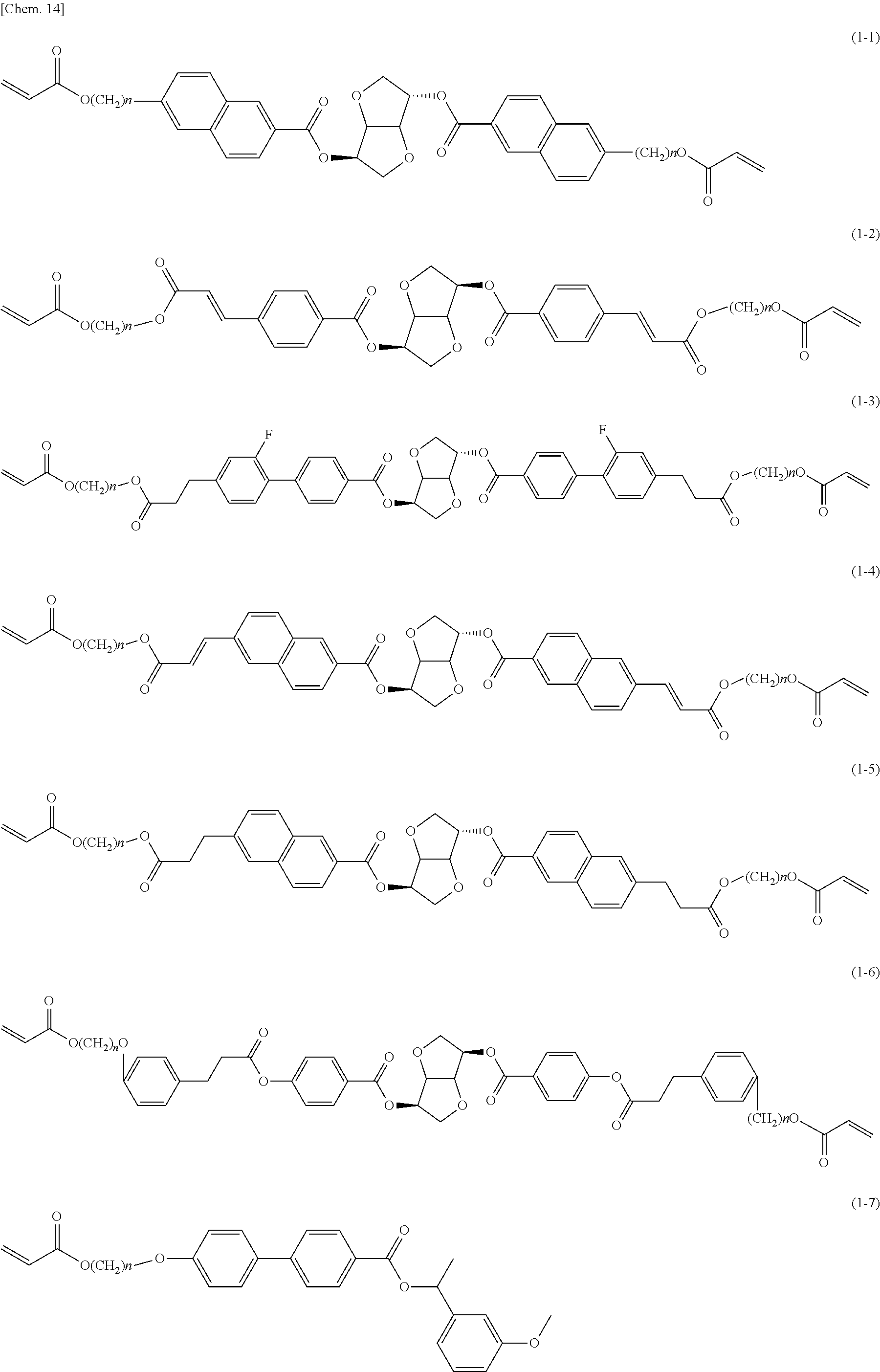

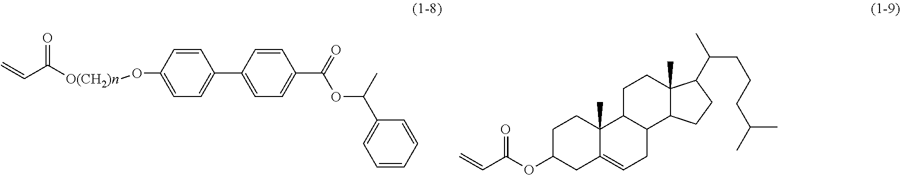

(in the formulae, n represents an integer of 0 to 12) In addition, specific examples of chiral compounds can further include compounds denoted by formulae (1-10) to (1-14).

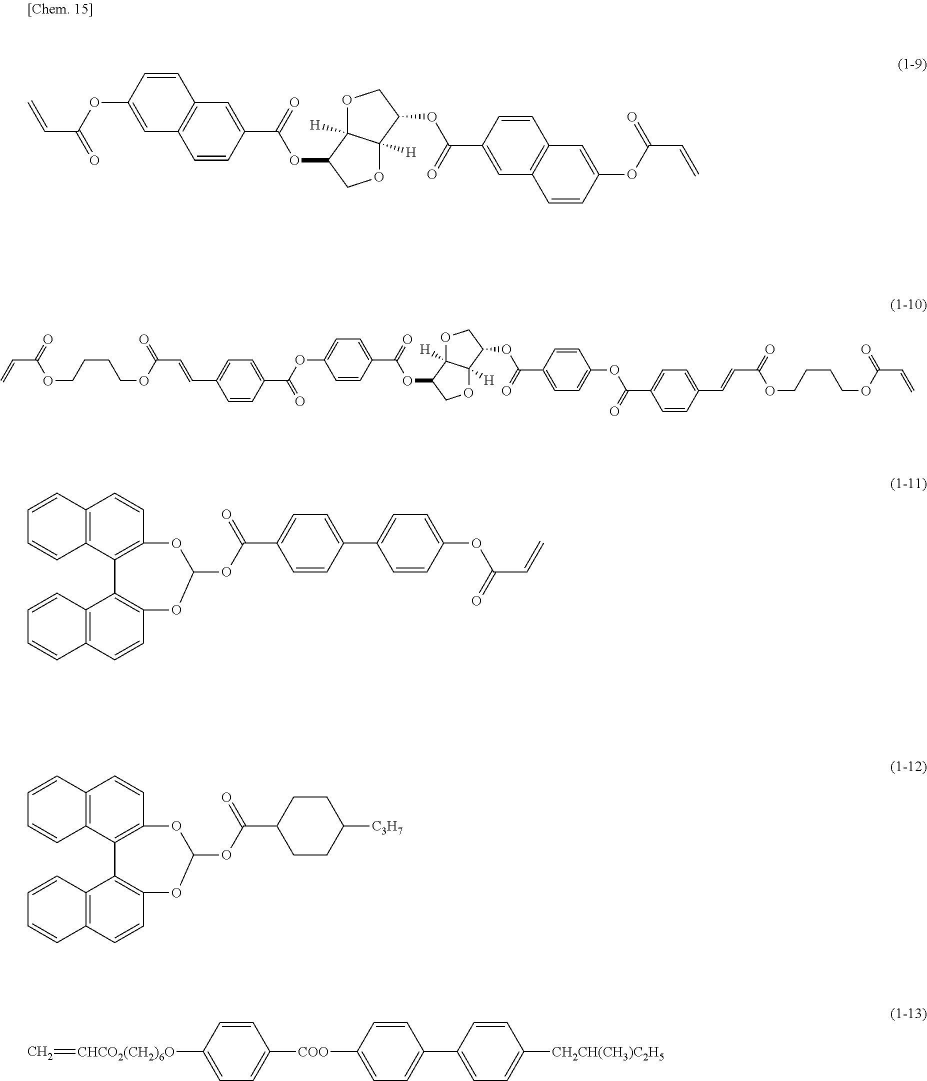

(Fluorosurfactant)

The polymerizable liquid crystal composition according to the present invention contains at least one fluorosurfactant selected from the group consisting of compounds having a pentaerythritol skeleton or a dipentaerythritol skeleton.

In the case where the fluorosurfactant is used, the polymerizable liquid crystal composition according to the present invention has excellent solution stability because good compatibility between the polymerizable compound and the fluorosurfactant is ensured and, when being made into an optically anisotropic body, the surface leveling properties and the offset properties can be improved at the same time while excellent alignment properties are maintained.

It is preferable that the fluorosurfactant be composed of only carbon atom, hydrogen atom, oxygen atom, fluorine atom, and sulfur atom. It is considered that the compatibility between the surfactant composed of these atoms and the polymerizable compound is enhanced because these atoms are the same as the atoms constituting the structure (spacer (Sp) portion and mesogen (MG) portion) other than the end portion (end group) of the polymerizable compound used in the present invention.

Regarding the compound having a pentaerythritol skeleton, a compound denoted by general formula (III-1) described below is used.

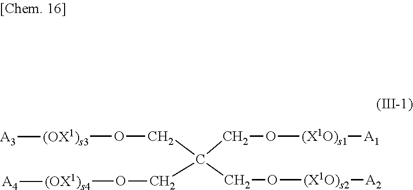

(In the formula, X¹ represents an alkylene group, s1 represents a numerical value of 1 to 80, each of s2 to s4 represents a numerical value of 0 to 79, s1+s2+s3+s4 represents a numerical value of 4 to 80, A₁ represents a fluoroalkyl group or a fluoroalkenyl group, and each of A₂ to A₄ represents a hydrogen atom, an acryloyl group, a methacryloyl group, a fluoroalkyl group, or a fluoroalkenyl group.)

In general formula (III-1), X¹ represents an alkylene group, preferably an ethylene group or a propylene group, and more preferably an ethylene group.

In general formula (III-1), s1 represents a numerical value of 1 to 80, preferably 1 to 60, and particularly preferably 1 to 40, each of s2 to s4 represents a numerical value of 0 to 79, preferably 0 to 65, and particularly preferably 0 to 50, and s1+s2+s3+s4 represents a numerical value of 4 to 80, preferably 4 to 40, and particularly preferably 4 to 30.

In general formula (III-1), A₁ represents a fluoroalkyl group or a fluoroalkenyl group, the carbon atom number of the fluoroalkyl group or the fluoroalkenyl group is preferably 3 to 10 and more preferably 4 to 9, a straight-chain or branched shape may be taken, and each of A₂ to A₄ represents a hydrogen atom, an acryloyl group, a methacryloyl group, a fluoroalkyl group, or a fluoroalkenyl group, the carbon atom number of the fluoroalkyl group or the fluoroalkenyl group is preferably 3 to 10 and more preferably 4 to 9, and a straight-chain or branched shape may be taken. Also, A₁ to A4 is preferably a fluoroalkenyl group, and a branched fluorononenyl group is particularly preferable.

The compound denoted by general formula (III-1) is produced by, for example, introducing alkylene oxide into pentaerythritol by addition and, then, substituting active hydrogen at the end of the adduct with a fluoroalkyl group or a fluoroalkenyl group. In this regard, a hydrocarbon group, e.g., long-chain alkyl, acrylic acid, methacrylic acid, a reactive functional group, e.g., a glycidyl group, or the like may be introduced into an active hydrogen group, into which a fluoroalkyl group or a fluoroalkenyl group has not been introduced.

Examples of the compound having a pentaerythritol skeleton include compounds denoted by general formula (III-1a) described below.

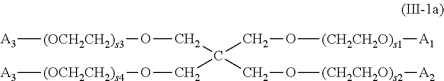

(in the formula, A₁ represents any one of groups denoted by formula (Rf-1-1) to formula (Rf-1-8) described below, and each of A₂ to A₄ represents a hydrogen atom or any one of groups denoted by formula (Rf-1-1) to formula (Rf-1-9) described below)

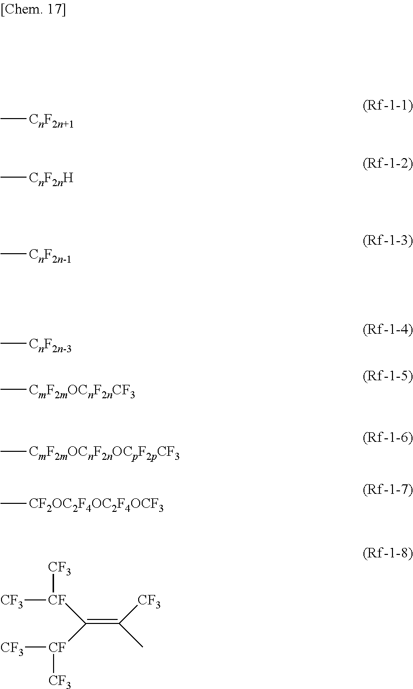

(in formulae (Rf-1-1) to (Rf-1-4) described above, n represents an integer of 4 to 6, in formula (Rf-1-5) described above, m represents an integer of 1 to 5, n represents an integer of 0 to 4, and the total of m and n is 4 to 5, and in formula (Rf-1-6) described above, m represents an integer of 0 to 4, n represents an integer of 1 to 4, p represents an integer of 0 to 4, and the total of m, n, and p is 4 to 5)

Also, more preferable examples of general formula (III-1a) described above include general formula (III-1a-1) described below.

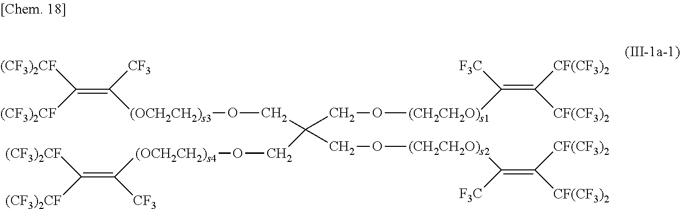

(in the formula, s1 represents a numerical value of 1 to 80, preferably 1 to 60, and particularly preferably 1 to 40, each of s2 to s4 represents a numerical value of 0 to 79, preferably 0 to 65, and particularly preferably 0 to 50, and s1+s2+s3+s4 represents a numerical value of 4 to 80, preferably 4 to 40, and particularly preferably 4 to 30)

Regarding the compound having a dipentaerythritol skeleton, a compound denoted by general formula (III-2) described below is used.

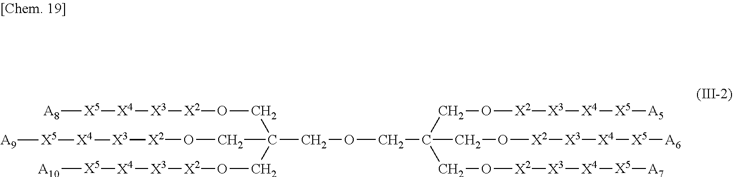

(in the formula, each of X², X³, X⁴, and X⁵ represents a single bond, —O—, —S—, —CO—, an alkyl group having a carbon atom number of 1 to 4, or an oxyalkylene group, A₅ represents a fluoroalkyl group or a fluoroalkenyl group, and each of A₆ to A₁₀ represents a hydrogen atom, an acryloyl group, a methacryloyl group, a fluoroalkyl group, or a fluoroalkenyl group)

In general formula (III-2), A₅ represents a fluoroalkyl group or a fluoroalkenyl group, the carbon atom number of the fluoroalkyl group or the fluoroalkenyl group is preferably 3 to 10 and more preferably 4 to 9, and a straight-chain or branched shape may be taken. Each of A₆ to A₁₀ represents a hydrogen atom, an acryloyl group, a methacryloyl group, a fluoroalkyl group, or a fluoroalkenyl group, the carbon atom number of the fluoroalkyl group or the fluoroalkenyl group is preferably 3 to 10 and more preferably 4 to 9, and a straight-chain or branched shape may be taken. A₅ represents preferably a fluoroalkyl group and particularly preferably a straight-chain fluoroalkyl group, and each of A₆ to A₁₀ represents preferably an acryloyl group, a methacryloyl group, or a fluoroalkyl group and particularly preferably an acryloyl group or a straight-chain fluoroalkyl group. It is particularly preferable that at least one of A₆ to A₁₀ is an acryloyl group.

The compound denoted by general formula (III-2) is produced by, for example, reacting a monothiol monomer having a fluoroalkyl group or a fluoroalkenyl group with a polyfunctional acrylate of pentaerythritol by Michael addition.

Examples of the compound having a dipentaerythritol skeleton include a compound denoted by general formula (III-2a) described below.

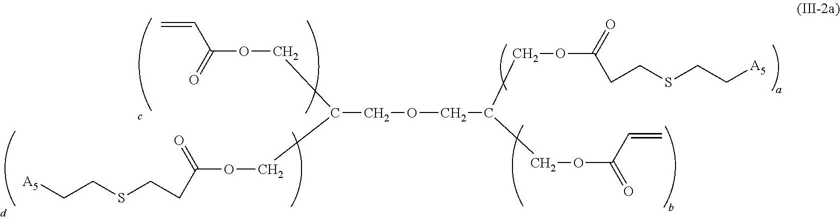

(in the formula, each of a and b represents an integer of 1 or 2 and satisfies a+b=3, each of c and d is an integer of 0 to 3 and satisfies c+d=3, and A₅ represents any one of groups denoted by formula (Rf-2-1) to formula (Rf-2-8))

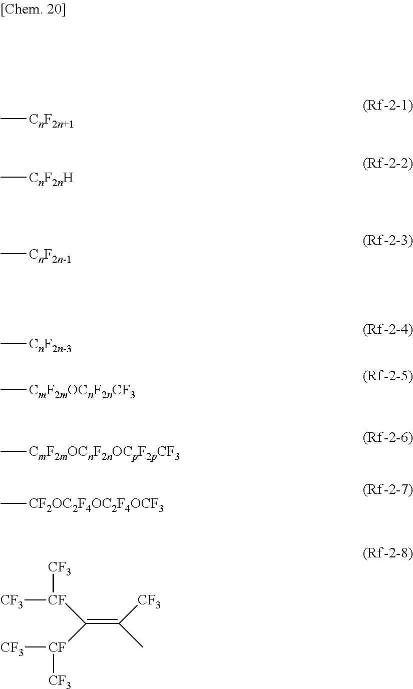

(in formulae (Rf-2-1) to (Rf-2-4) described above, n represents an integer of 4 to 6, in formula (Rf-2-5) described above, m represents an integer of 1 to 5, n represents an integer of 0 to 4, and the total of m and n is 4 to 5, and in formula (Rf-2-6) described above, m represents an integer of 0 to 4, n represents an integer of 1 to 4, p represents an integer of 0 to 4, and the total of m, n, and p is 4 to 5)

Also, more preferable examples of general formula (III-2a) described above include general formula (III-2a-1) described below.

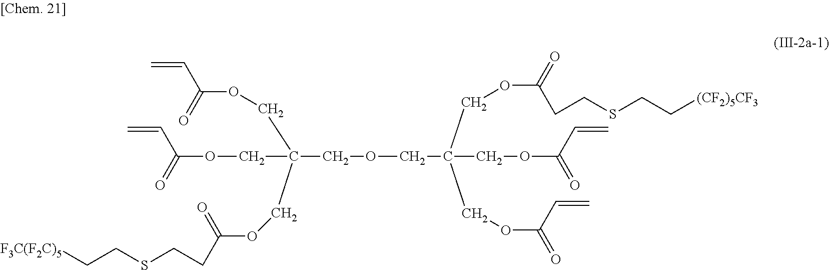

The amount of the fluorosurfactant added is preferably 0.005 to 5 percent by mass relative to the total amount of the polymerizable compound and chiral compound, more preferably 0.01 to 3 percent by mass, and further preferably 0.05 to 2.0 percent by mass.

(Other Liquid Crystal Compounds)

Liquid crystal compounds not having a polymerizable group may be added to the polymerizable liquid crystal composition according to the present invention as necessary. However, if the amount of addition is excessive, the liquid crystal compounds may ooze from the resulting optically anisotropic body and, as a result, a multilayer member may be polluted. In addition, the heat resistance of the optically anisotropic body may be degraded. Therefore, in the case where the addition is performed, the amount of addition is set to be preferably 30 percent by mass or less relative to the total amount of the polymerizable liquid crystal compound, further preferably 15 percent by mass or less, and particularly preferably 5 percent by mass or less.

(Polymerization Initiator)

The polymerizable liquid crystal composition according to the present invention preferably contains at least one polymerization initiator, e.g., a thermal polymerization initiator and a photopolymerization initiator. Examples of thermal polymerization initiators include benzoyl peroxide and 2,2′-azobisisobutyronitrile. Also, examples of photopolymerization initiators include benzoin ethers, benzophenones, acetophenones, benzyl ketals, and thioxanthones. Specific examples include “Irgacure 651”, “Irgacure 184”, “Irgacure 907”, “Irgacure 127”, “Irgacure 369”, “Irgacure 379”, “Irgacure 819”, “Irgacure OXE01”, “Irgacure OXEO2”, “Lucirin TPO”, and “Darocur 1173” by BASF and “Esacure 1001M”, “Esacure KIP150”, “Speedcure BEM”, “Speedcure BMS”, “Speedcure PBZ”, and “Benzophenone” by LAMBSON. Further, a photoacid generator can be used as a photo cationic initiator. Regarding the photoacid generator, preferably, a diazosulfone-based compound, a triphenylsulfonium-based compound, a phenylsulphone-based compound, a sulfonylpirydine-based compound, a triazine-based compound, and a diphenyliodonium compound are used.

The amount of the photopolymerization initiator used is preferably 0.1 to 10 percent by mass relative to the polymerizable liquid crystal composition, and particularly preferably 0.5 to 5 percent by mass. These can be used alone, or at least two types can be used in combination. Also, a sensitizing agent and the like may be added.

The polymerizable liquid crystal composition according to the present invention can include a compound that has a polymerizable group but is not a polymerizable liquid crystal compound. There is no particular limitation regarding use of such a compound as long as the compound is usually recognized to be a polymerizable monomer or a polymerizable oligomer in the related art. In the case where addition is performed, the amount is preferably 15 percent by mass or less relative to the total amount of the polymerizable compound and chiral compound used for the polymerizable liquid crystal composition according to the present invention, and further preferably 10 percent by mass or less.

(Other Compounds)

The polymerizable liquid crystal composition according to the present invention may contain at least one compound having a repletion unit denoted by general formula (3) described below and having a weight average molecular weight of 100 or more for the purpose of effectively decreasing the tilt angle at the interface to the air when the polymerizable liquid crystal composition is made into an optically anisotropic body.

[Chem. 22]

\CR³⁶R³⁷—CR³⁸R³⁹ (3)

(in the formula, each of R³⁶, R³⁷, R³⁸, and R³⁹ represents a hydrogen atom, a halogen atom, or a hydrocarbon group having a carbon atom number of 1 to 20, and hydrogen atoms in the hydrocarbon group may be substituted with at least one halogen atom)

Examples of preferable compounds denoted by general formula (3) can include polyethylenes, polypropylenes, polyisobutylenes, paraffin, liquid paraffin, chlorinated polypropylenes, chlorinated paraffin, and chlorinated liquid paraffin.

The amount of the compound, which is denoted by general formula (3), added is preferably 0.01 to 1 percent by mass relative to the polymerizable liquid crystal composition, and more preferably 0.05 to 0.5 percent by mass.

(Chain Transfer Agent)

The polymerizable liquid crystal composition according to the present invention preferably includes a chain transfer agent for the purpose of further improving adhesion to the base material when the polymerizable liquid crystal composition is made into an optically anisotropic body. Regarding the chain transfer agent, thiol compounds are preferable, monothiol, dithiol, trithiol, tetrathiol compounds are more preferable, and trithiol compounds and tetrathiol compounds are further preferable. Specifically, compounds denoted by general formulae (4-1) to (4-12) described below are preferable.

[Chem. 23]

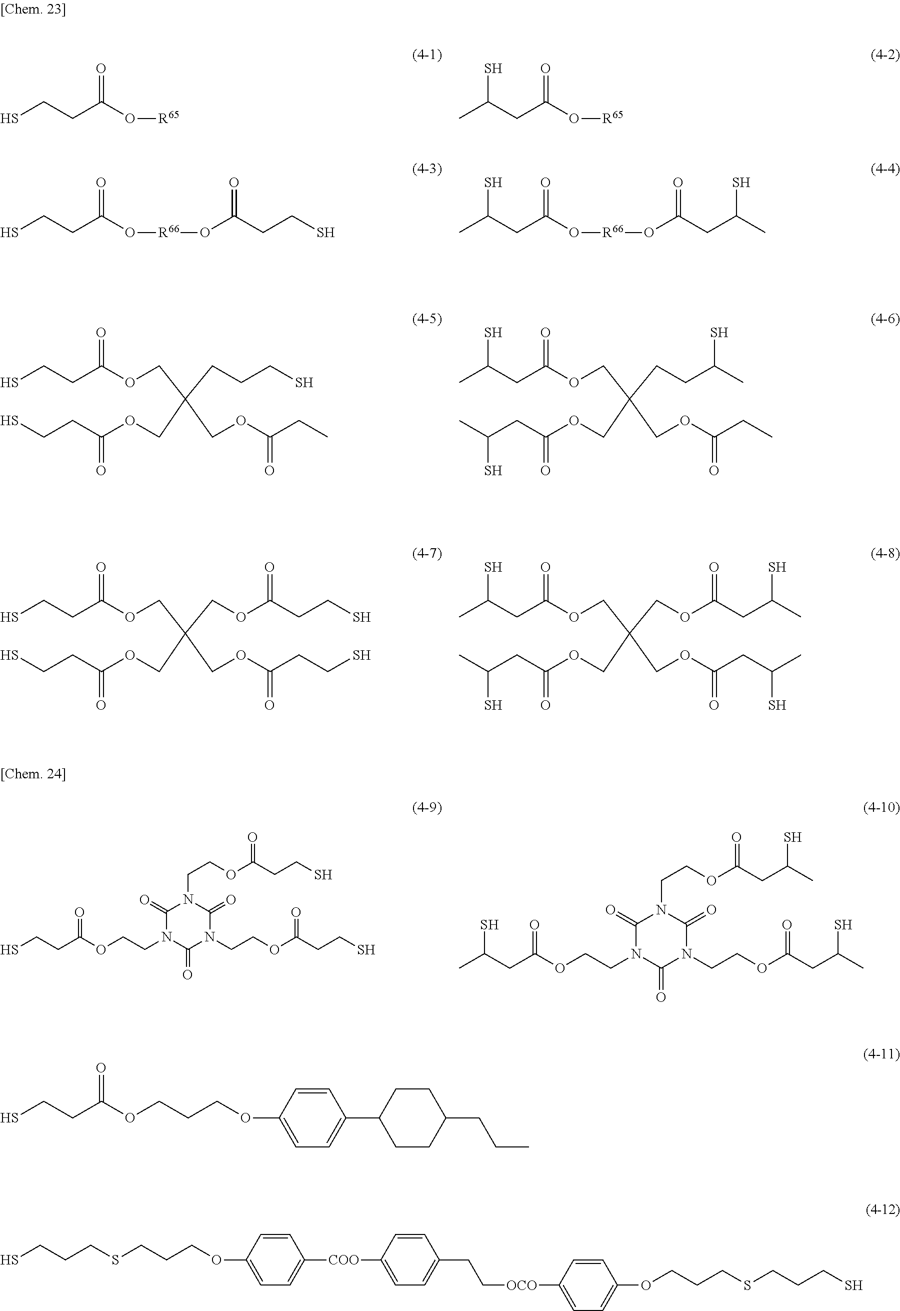

(in the formulae, R⁶⁵ represents an alkyl group having a carbon atom number of 2 to 18, the alkyl group may be a straight chain or a branched chain, at least one methylene group in the alkyl group may be substituted with an oxygen atom, a sulfur atom, —CO—, —OCO—, —COO—, or —CH═CH— as long as an oxygen atom and a sulfur atom do not directly bond to each other, R⁶⁶ represents an alkylene group having a carbon atom number of 2 to 18, and at least one methylene group in the alkylene group may be substituted with an oxygen atom, a sulfur atom, —CO—, —OCO—, —COO—, or —CH═CH— as long as an oxygen atom and a sulfur atom do not directly bond to each other)

The amount of the thiol compound added is preferably 0.5 to 10 percent by mass relative to the polymerizable composition, and more preferably 1.0 to 5.0 percent by mass.

(Other Additives)

Also, it is preferable that a polymerization inhibitor, an antioxidant, and the like be added for the purpose of enhancing the solution stability of the polymerizable liquid crystal composition according to the present invention. Examples of such compounds include hydroquinone derivatives, nitrosamine-based polymerization inhibitors, and hindered phenol-based antioxidants. More specific examples include p-methoxyphenol, tert-butylhydroquinone, methylhydroquinone, “Q-1300” and “Q-1301” by Wako Pure Chemical Industries, Ltd., and “IRGANOX 1010”, “IRGANOX 1035”, “IRGANOX 1076”, “IRGANOX 1098”, “IRGANOX 1135”, “IRGANOX 1330”, “IRGANOX 1425”, “IRGANOX 1520”, “IRGANOX 1726”, “IRGANOX 245”, “IRGANOX 259”, “IRGANOX 3114”, “IRGANOX 3790”, “IRGANOX 5057”, and “IRGANOX 565” by BASF.

The amount of the polymerization inhibitor and the antioxidant added is preferably 0.01 to 1.0 percent by mass relative to the polymerizable liquid crystal composition, and more preferably 0.05 to 0.5 percent by mass.

In the case where the polymerizable liquid crystal composition according to the present invention is used for applications such as raw materials for a polarization film and an alignment film, a printing ink, a paint, and a protective film, in accordance with the purpose, a metal, a metal complex, a dye, a pigment, a fluorescent material, a phosphorescent material, a thixotropic agent, a gelatinizer, polysaccharide, an ultraviolet absorber, an infrared absorber, an antioxidant, an ion-exchange resin, and a metal oxide, e.g., titanium oxide, may be added.

(Organic Solvent)

There is no particular limitation regarding an organic solvent used for the polymerizable liquid crystal composition according to the present invention. A solvent, into which the polymerizable compound exhibits good solubility, is preferable, and a solvent that can be dried at a temperature of 100° C. or lower is preferable. Examples of such solvents include aromatic hydrocarbons, e.g., toluene, xylene, cumene, and mesitylene, ester-based solvents, e.g., methyl acetate, ethyl acetate, propyl acetate, and butyl acetate, ketone-based solvents, e.g., methyl ethyl ketone, methyl isobutyl ketone, cyclohexanone, and cyclopentanone, ether-based solvents, e.g., tetrahydrofuran, 1,2-dimethoxyethane, and anisole, amide-based solvents, e.g., N,N-dimethylformamide and N-methyl-2-pyrrolidone, propylene glycol monomethyl ether acetate, diethylene glycol monomethyl ether acetate, y-butyrolactone, and chlorobenzene. These can be used alone, or at least two types can be used in combination. It is preferable that at least one of ketone-based solvents, ether-based solvents, ester-based solvents, and aromatic hydrocarbon-based solvents be used. In the case where two types are used in combination, it is preferable that any one of ketone-based solvents and ester-based solvents be used by mixing from the viewpoint of solution stability.

The polymerizable liquid crystal composition is usually used by coating in the present invention. Therefore, there is no particular limitation regarding the proportion of the organic solvent in the polymerizable liquid crystal composition as long as a coated state is not significantly impaired. The solid content of the polymerizable liquid crystal composition is preferably 10 to 60 percent by mass, and further preferably 20 to 50 percent by mass.

(Method for Manufacturing Optically Anisotropic Body)

(Optically Anisotropic Body)

The optically anisotropic body according to the present invention is produced by coating a base material, which has an alignment function, with the polymerizable liquid crystal composition according to the present invention, uniformly aligning liquid crystal molecules in the polymerizable liquid crystal composition while the nematic phase is maintained, and performing polymerization.

(Base Material)

There is no particular limitation regarding the base material used for the optically anisotropic body according to the present invention as long as the base material is commonly used for a liquid crystal device, a display, an optical member, and an optical film and the material has heat resistance so as to resist heating during drying after application of a polymerizable composition solution according to the present invention. Examples of such base materials include glass base materials, metal base materials, ceramic base materials, and organic materials, e.g., plastic base materials. In particular, in the case where the base material is an organic material, examples thereof include cellulose derivatives, polyolefins, polyesters, polyolefins, polycarbonates, polyacrylates, polyarylates, polyether sulfones, polyimides, polyphenylene sulfides, polyphenylene ethers, nylons, and polystyrenes. In particular, plastic base materials, e.g., polyesters, polystyrenes, polyolefins, cellulose derivatives, polyarylates, and polycarbonates, are preferable. The shape of the base material may be a flat shape and, in addition, may be a shape having a curved surface. These base materials may have an electrode layer, an antireflection function, or a reflection function, as necessary.

These base materials may be subjected to surface treatment for the purpose of enhancing the application properties and adhesive properties of the polymerizable liquid crystal composition solution according to the present invention. Examples of surface treatment include ozone treatment, plasma treatment, corona treatment, and silane coupling treatment. Meanwhile, in order to adjust the transmittance and the reflectance of the light, an organic thin film, an inorganic oxide thin film, a metal thin film, or the like may be disposed by evaporation or the like on the base material surface. Alternatively, in order to provide an optical added value, the base material may be a pickup lens, a rod lens, an optical disc, a phase difference film, a light diffusion film, a color filter, and the like. In particular, a pickup lens, a phase difference film, a light diffusion film, and a color filter are preferable because the added value further increases.

(Alignment Treatment)

The above-described base material may be subjected to common alignment treatment or be provided with an alignment film such that the polymerizable composition is aligned when the polymerizable composition solution according to the present invention is applied and dried. Examples of alignment treatment include stretching treatment, rubbing treatment, polarized ultraviolet-visible light irradiation treatment, ion beam treatment, and SiO₂ oblique evaporation treatment of the base material. In the case where the alignment film is used, a known common alignment film is used. Examples of such alignment films include compounds, e.g., a polyimide, a polysiloxane, a polyamide, a polyvinyl alcohol, a polycarbonate, a polystyrene, a polyphenylene ether, a polyarylate, a polyethylene terephthalate, a polyether sulfone, an epoxy resin, an epoxy acrylate resin, an acrylic resin, a coumarin compound, a calcone compound, a cinnamate compound, a fulgide compound, an anthraquinone compound, an azo compound, and an arylethene compound. It is preferable that the compound to be subjected to the alignment treatment by rubbing be a compound in which crystallization of a material is facilitated by the alignment treatment or by performing a heating step after the alignment treatment. Regarding the compounds subjected to an alignment treatment other than rubbing, it is preferable that photo-alignment material be used.

In general, in the case where a liquid crystal composition comes into contact with a substrate having an alignment function, liquid crystal molecules are aligned in the vicinity of the substrate in the direction in which the substrate has been subjected to the alignment treatment. Whether liquid crystal molecules are aligned so as to become horizontal to the substrate or are aligned slantingly or vertically is influenced to a large extent by the alignment treatment method for the substrate. For example, in the case where an alignment film that has a very small tilt angle and that is used for an in-plane switching (IPS) liquid crystal display element is disposed on the substrate, a substantially horizontally aligned polymerizable liquid crystal layer is obtained.

Meanwhile, in the case where an alignment film that is used for a TN liquid crystal display element is disposed on the substrate, a polymerizable liquid crystal layer aligned slantingly to a small extent is obtained. In the case where an alignment film that is used for an STN liquid crystal display element is used, a polymerizable liquid crystal layer aligned slantingly to a large extent is obtained.

When a liquid crystal composition comes into contact with a substrate that has a very small tilt angle and that has a horizontal alignment (substantially horizontal alignment) function, liquid crystal molecules in the composition are uniformly horizontally aligned in the vicinity of the substrate but, in the vicinity of the interface to the air, alignment is partly disturbed because an alignment regulation force is not smoothly propagated (this is an alignment defect). However, it is considered that the polymerizable liquid crystal composition containing copolymer (S), according to the present invention, can produce a uniformly aligned optically anisotropic body having no alignment defect and exhibiting high optical anisotropy because copolymer (S) is unevenly distributed in the vicinity of the interface to the air and aligns liquid crystal molecules in the vicinity of the interface to the air without hindering the alignment regulation force, which is applied to liquid crystal molecules in the polymerizable liquid crystal composition, on the substrate side.

(Coating)

Regarding the coating method for producing the optically anisotropic body according to the present invention, known common methods, e.g., an applicator method, a bar coating method, a spin coating method, a roll coating method, a direct gravure coating method, a reverse gravure coating method, a flexo coating method, an ink jet method, a die coating method, a cap coating method, a dip coating method, and a slit coating method, can be performed. After the polymerizable liquid crystal composition is applied, drying is performed.

It is preferable that, after the coating is performed, liquid crystal molecules in the polymerizable liquid crystal composition according to the present invention be uniformly aligned while a nematic phase is maintained. Specifically, it is preferable that heat treatment for facilitating alignment of the liquid crystal be performed because the copolymer (S) can be more unevenly distributed on the surface and alignment can be further facilitated. Regarding the heat treatment method, for example, the polymerizable liquid crystal composition according to the present invention is applied to a substrate and, thereafter, heating to an N (nematic phase)-I (isotropic liquid phase) transition temperature (hereafter abbreviated as transition temperature) of the liquid crystal composition or higher is performed so as to make the liquid crystal composition into an isotropic liquid state. Then, gradual cooling is performed, as necessary, so as to realize a nematic phase. At this time, it is desirable that a temperature, at which a liquid crystal phase is realized, be temporarily maintained and, thereby, a liquid crystal phase domain be sufficiently grown so as to form a monodomain. Alternatively, the polymerizable liquid crystal composition according to the present invention is applied to a substrate and, thereafter, heating treatment may be performed such that the temperature is maintained in a temperature range, in which a nematic phase of the polymerizable liquid crystal composition according to the present invention is realized, for a predetermined time.

If the heating temperature is excessively high, the polymerizable liquid crystal compound may be degraded because of an occurrence of unfavorable polymerization reaction. Meanwhile, if cooling is performed excessively, phase separation of the polymerizable liquid crystal composition may occur, crystals may be precipitated, a highly ordered liquid crystal phase such as a smectic phase may be realized, and alignment treatment may become impossible.

In the case where such heat treatment is performed, homogeneous optically anisotropic body having reduced alignment defects can be produced compared with the coating method in which only coating is performed.

In addition, in the case where, after uniform alignment treatment is performed as described above, cooling is performed to the lowest temperature, at which phase separation of the liquid crystal phase does not occur, that is, until a supercooled state is reached, and polymerization is performed while the liquid crystal phase is aligned at that temperature, an optically anisotropic body having higher alignment order and excellent transparency can be obtained.

(Polymerization Step)

In general, polymerization treatment of the dried polymerizable composition in the state of planar alignment is performed by light irradiation using ultraviolet rays or the like or heating. In the case where the polymerization is performed by light irradiation, specifically, it is preferable to radiate ultraviolet light with 390 nm or less, and it is most preferable to radiate the light with a wavelength of 250 to 370 nm. However, in the case where decomposition or the like of the polymerizable composition is caused due to ultraviolet light with 390 nm or less, it may be preferable to perform polymerization treatment by using ultraviolet light with 390 nm or more. Preferably, this light is diffused light and is unpolarized light.

(Polymerization Method)

Examples of methods for polymerizing the polymerizable liquid crystal composition according to the present invention include a method in which active energy rays are radiated and a thermal polymerization method. The method in which active energy rays are radiated is preferable because heating is not necessary and the reaction proceeds at room temperature. In particular, a method in which ultraviolet light or the like is radiated is preferable because of ease of operation. The temperature during irradiation is set to be a temperature at which the polymerizable liquid crystal composition according to the present invention can maintain a liquid crystal phase and is preferably 30° C. or lower as much as possible for the purpose of avoiding induction of thermal polymerization of the polymerizable liquid crystal composition. In this regard, a liquid crystal composition usually has a liquid crystal phase in the range of a C (solid phase)-N (nematic) transition temperature (hereafter abbreviated as C—N transition temperature) to an N—I transition temperature in the process of temperature increase. Meanwhile, in the process of temperature decrease, the liquid crystal composition is in a thermodynamically non-equilibrium state and, therefore, may maintain the liquid crystal state without solidifying even at the C—N transition temperature or lower. This state is referred to as a supercooled state. In the present invention, the liquid crystal composition in the supercooled state is included in the state in which the liquid crystal phase is maintained. Specifically, it is preferable to radiate ultraviolet light with 390 nm or less, and it is most preferable to radiate the light with a wavelength of 250 to 370 nm. However, in the case where decomposition or the like of the polymerizable composition is caused due to ultraviolet light with 390 nm or less, it may be preferable to perform polymerization treatment by using ultraviolet light with 390 nm or more. Preferably, this light is diffused light and is unpolarized light. The ultraviolet radiation intensity is preferably within the range of 0.05 kW/m² to 10 kW/m². In particular, the range of 0.2 kW/m² to 2 kW/m² is preferable. If the ultraviolet intensity is less than 0.05 kW/m², it takes much time until the polymerization is completed. On the other hand, if the intensity is more than 2 kW/m², liquid crystal molecules in the polymerizable liquid crystal composition tend to be photodecomposed and, in addition, much heat of polymerization is generated, the temperature increases during the polymerization, the order parameter of polymerizable liquid crystal is varied, and the retardation of the film after polymerization may become out of order.

An optically anisotropic body having a plurality of regions with alignment directions different from each other can also be obtained by polymerizing only a specific portion by radiating ultraviolet rays while a mask is used, changing the alignment state of the unpolymerized portion by applying an electric field, a magnetic field, a temperature, or the like and, thereafter, polymerizing the unpolymerized portion.

Also, optically anisotropic body having a plurality of regions with alignment directions different from each other can be obtained by regulating the alignment in advance by applying an electric field, a magnetic field, a temperature, or the like to the polymerizable liquid crystal composition in an unpolymerized state when only a specific portion is polymerized by radiating ultraviolet rays while a mask is used, and performing polymerization by radiating the light from above the mask while the above-described state is maintained.

The optically anisotropic body produced by polymerizing the polymerizable liquid crystal composition according to the present invention can be peeled from the substrate so as to be used alone as an optically anisotropic body or can be used as an optically anisotropic body on an “as is” basis without being peeled from the substrate. In particular, the resulting optically anisotropic body does not easily pollute another member and, therefore, is valuable for the use as a substrate, on which stacking is performed, or for the use by being bonded to another substrate.

(Phase Difference Film)

The optically anisotropic body according to the present invention can be used as a phase difference film. It is necessary that the phase difference film contain the optically anisotropic body and a liquid crystal compound form a continuous uniform alignment state on a in-plane, out-of-plane, or both in-plane and out-of-plane basis relative to the base material or have in-plane biaxiality. Also, an adhesive, an adhesive layer, a pressure-sensitive adhesive, a pressure-sensitive adhesive layer, a protective film, a polarization film, and the like may be stacked.

Regarding such a phase difference film, alignment modes of, for example, a positive A-plate in which a rod-like liquid crystal compound is substantially horizontally aligned relative to a base material, a negative A-plate in which a disc-like liquid crystal compound is vertically uniaxially aligned relative to a base material, a positive C-plate in which a rod-like liquid crystal compound is substantially vertically aligned relative to a base material, a negative C-plate in which a rod-like liquid crystal compound is in cholesteric alignment or a disc-like liquid crystal compound is horizontally uniaxially aligned relative to a base material, a biaxial plate, a positive O-plate in which the inclination relative to the base material of a rod-like liquid crystal compound in hybrid alignment varies to the base material thickness direction, and a negative O-plate in which a disc-like liquid crystal compound is in hybrid alignment relative to a base material can be applied. In the case where the phase difference film is used for a liquid crystal display element, various alignment modes can be applied with no limitation as long as the alignment modes improve the viewing angle dependence.

For example, the alignment modes of the positive A-plate, the negative A-plate, the positive C-plate, the negative C-plate, the biaxial plate, the positive O-plate, and the negative O-plate can be applied. In particular, it is preferable that the positive A-plate and the negative C-plate be used. Further, it is more preferable that the positive A-plate and the negative C-plate be stacked.

Here, the positive A-plate refers to an optically anisotropic body in which a polymerizable composition is homogeneously aligned. Also, the negative C-plate refers to an optically anisotropic body in which the polymerizable composition is in cholesteric alignment.

In a liquid crystal cell by using the phase difference film, in order to increase the viewing angle by compensating the viewing angle dependence of the polarization axis orthogonality, it is preferable that the positive A-plate be used as a first phase difference layer. Here, regarding the positive A-plate, the relationship “nx>ny=nz” holds where the refractive index of the phase difference layer in the in-plane slow axis direction is assumed as nx, the refractive index of the phase difference layer in the in-plane fast axis direction is assumed as ny, and the refractive index of the phase difference layer in the thickness direction is assumed as nz. The positive A-plate preferably has an in-plane phase difference value within the range of 30 to 500 nm at a wavelength of 550 nm. Meanwhile, there is no particular limitation regarding the thickness direction phase difference value. The Nz coefficient is preferably within the range of 0.9 to 1.1.

In addition, in order to cancel birefringence of the liquid crystal molecule itself, it is preferable that a so-called negative C-plate having negative refractive index anisotropy be used as a second phase difference layer. Also, the negative C-plate may be stacked on the positive A-plate.

Here, the negative C-plate is a phase difference layer satisfying the relationship “nx=ny>nz” where the refractive index of the phase difference layer in the in-plane slow axis direction is assumed as nx, the refractive index of the phase difference layer in the in-plane fast axis direction is assumed as ny, and the refractive index of the phase difference layer in the thickness direction is assumed as nz. The thickness direction phase difference value of the negative C-plate is preferably within the range of 20 to 400 nm.

In this regard, the thickness direction refractive index anisotropy is represented by a thickness direction phase difference value Rth defined by formula (2) described below. The thickness direction phase difference value Rth can be calculated by determining nx, ny, and nz on the basis of numerical calculation using the in-plane phase difference value R₀, the phase difference value R₅₀ measured with inclination of the slow axis, which is an inclination axis, of 50°, the thickness d of the phase difference layer, and the average refractive index n₀ of the phase difference layer, and using formula (1) and formulae (4) to (7) described below and by substituting nx, ny, and nz into formula (2). Also, the Nz coefficient can be calculated by using formula (3). The same goes for the following other descriptions in the present specification.

R₀=(nx−ny)×d (1)

Rth=[(nx+ny)/2−nz]×d (2)

Nz coefficient=(nx−nz)/(nx−ny) (3)

R₅₀=(nx−ny′)×d/cos(ϕ) (4)

(nx+ny+nz)/3=n₀ (5)

### Where,

ϕ=sin⁻¹[ sin(50°)/n₀] (6)

ny′=ny×nz/[ny²×sin²(ϕ)+nz²×cos²(ϕ)]^{1/2} (7)

Most of commercially available phase difference measuring apparatuses automatically perform the numerical calculation described here in the apparatuses and automatically display the in-plane phase difference value R₀, the thickness direction phase difference value Rth, and the like. Examples of such measuring apparatuses can include RETS-100 (produced by Otsuka Chemical Co., Ltd.).

(Liquid Crystal Display Element)

The polymerizable composition according to the present invention can be used for a liquid crystal display element according to the present invention by coating a base material or a base material that has an alignment function with the polymerizable composition, performing uniform alignment while a nematic phase and a smectic phase are maintained, and performing polymerization. Examples of use forms include an optical compensation film, a patterned phase difference film of a liquid crystal stereoscopic display element, a phase difference correction layer of a color filter, an overcoat layer, and an aligning film for a liquid crystal medium. Regarding the liquid crystal display element, at least a liquid crystal medium layer, a TFT driving circuit, a black matrix layer, a color filter layer, a spacer, and an electrode circuit suitable for the liquid crystal medium layer are interposed between at least two base materials and, usually, an optical compensation layer, a polarizing plate layer, and a touch panel layer are arranged outside the two base materials. However, in some cases, an optical compensation layer, an overcoat layer, a polarizing plate layer, and an electrode layer for a touch panel may be interposed between two base materials.

Examples of alignment modes of the liquid crystal display element include a TN mode, a VA mode, an IPS mode, an FFS mode, and an OCB mode. In the case of use for an optical compensation film or an optical compensation layer, a film having a phase difference suitable for the alignment mode can be formed. In the case of use for a patterned phase difference film, the liquid crystal compound in the polymerizable composition has to be substantially horizontally aligned relative to the base material. In the case of use for the overcoat layer, a liquid crystal compound having a larger amount of polymerizable group in the molecule may be thermally polymerized. In the case of use for the alignment film for a liquid crystal medium, it is preferable that a polymerizable composition, in which an alignment material and a liquid crystal compound having a polymerizable group are mixed, be used. In addition, mixing into a liquid crystal medium is possible and an effect of improving various characteristics, e.g., a response speed and a contrast, is exerted in accordance with the ratio of the liquid crystal medium to the liquid crystal compound.

### EXAMPLES

The present invention will be described below with reference to synthesis examples, examples, and comparative examples but the present invention is not limited to these, as a matter of course. In this regard, “part” and “%” are on a mass basis unless otherwise specified.

### Example 1

Polymerizable liquid crystal composition (1) of example 1 was obtained by agitating 30 parts of compound denoted by formula (A-1), 30 parts of compound denoted by formula (A-2), 15 parts of compound denoted by formula (B-1), 15 parts of compound denoted by formula (B-2), 10 parts of compound denoted by formula (B-3), 0.1 parts of compound denoted by formula (E-1), 5 parts of compound denoted by formula (F-1), 0.10 parts of compound denoted by formula (H-1) that was a surfactant, and 300 parts of methyl isobutyl ketone (G-1) that was an organic solvent for 1 hour under the condition of an agitation rate of 500 rpm and a solution temperature of 80° C. by using an agitator with an agitating propeller and, thereafter, performing filtration with a 0.2-μm membrane filter.

(Evaluation of Leveling Properties)

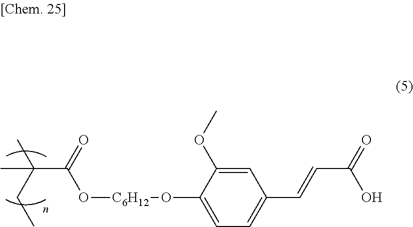

Base material (a), on which a photo-alignment film was stacked, was produced by coating a TAC film with a photo-alignment polymer denoted by formula (5) described above by using a bar coater, performing drying at 80° C. for 1 minute, and irradiating the coating film having a dry film thickness of 40 nm with visible-ultraviolet light (radiation intensity: 20 mW/cm²), which was linearly polarized light and parallel light, with a wavelength of about 365 nm in the direction perpendicular to the base material by an extra-high pressure mercury lamp through a wavelength cut filter, a band-pass filter, and a polarizing filter (cumulative amount of light: 100 mJ/cm²). Polymerizable liquid crystal composition (1) according to the present invention was applied by a bar coater #4 and was dried at 80° C. for 2 minutes. After being left to stand at room temperature for 15 minutes, the coating film having a dry film thickness of 1.0 μm was irradiated with UV light by using a conveyer type high pressure mercury lamp such that the cumulative amount of light of 500 mJ/cm² was achieved and, as a result, an optically anisotropic body that was a positive A-plate was produced. The manner of cissing of the resulting optically anisotropic body was visually observed, and no cissing defect was observed on the coating film surface. In this regard, the evaluation criteria were as described below.

⊙: No cissing defect was observed on the coating film surface.
◯: very few cissing defects were observed on the coating film surface.
Δ: A few cissing defects were observed on the coating film surface.
x: Many cissing defects were observed on the coating film surface.

(Evaluation of Offset)

The same TAC film (B) as a base material film used for applying the polymerizable liquid crystal composition was stacked on the polymerizable liquid crystal composition surface (A) of the optically anisotropic body produced as described above. A load of 40 g/cm² was applied and the stacking state was maintained at 80° C. for 30 minutes. Thereafter, cooling to room temperature was performed while the stacking state was maintained. Subsequently, film (B) was peeled, and whether offset of the surfactant in the polymerizable liquid crystal composition to film (B) occurred or not was visually observed. As a result, offset was slightly observed. In this regard, in the case where the surfactant was transferred to film (B), an offset portion was observed to be white turbidity. The evaluation criteria were as described below.

⊙: Offset was not observed.
O: Offset was slightly observed.
Δ: Offset was somewhat observed.
x: Offset was entirely observed.

(Evaluation of Alignment Properties)

Polymerizable liquid crystal composition (1) according to the present invention was applied to TAC (triacetyl cellulose) film (b), which had been subjected to rubbing treatment, at room temperature by a bar coater #4 and was dried at 80° C. for 2 minutes. After being left to stand at room temperature for 15 minutes, the coating film was irradiated with UV light by using a conveyer type high pressure mercury lamp while the cumulative amount of light was set to be 500 mJ/cm² and, as a result, an optically anisotropic body that was a positive A-plate was produced. The alignment properties of the resulting optically anisotropic body was evaluated visually and by a polarization microscope. As a result, no defect was visually observed, and no defect was observed by the polarization microscope. In this regard, the evaluation criteria were as described below.

⊙: No defect was visually observed, and no defect was observed by a polarization microscope.
◯: No defect was visually observed, but non-alignment portion was partly observed by a polarization microscope.
Δ: No defect was visually observed, but non-alignment portion was entirely observed by a polarization microscope.
x: Defects were visually partly observed, and non-alignment portion was entirely observed by a polarization microscope.

Table 1 to Table 4 show specific compositions of polymerizable liquid crystal compositions (1) to (26) according to the present invention and comparative polymerizable liquid crystal compositions (C1) to (C4).

TABLE 1

| Polymerizable | | | | | | | | |
|---|---|---|---|---|---|---|---|---|
| liquid crystal | | | | | | | | |
| composition | (1) | (2) | (3) | (4) | (5) | (6) | (7) | (8) |
| (A-1) | 30 | 30 | 30 | 30 | 30 | 40 | 40 | 40 |
| (A-2) | 30 | 30 | 30 | 30 | 30 | 40 | 40 | 40 |
| (A-3) | | | | | | 20 | 20 | 20 |
| (B-1) | 15 | 15 | 15 | 15 | 15 | | | |
| (B-2) | 15 | 15 | 15 | 15 | 15 | | | |
| (B-3) | 10 | 10 | 10 | 10 | 10 | | | |
| (E-1) | 0.1 | 0.1 | 0.1 | 0.1 | 0.1 | 0.1 | 0.1 | 0.1 |
| (F-1) | 5 | 5 | 5 | 5 | 5 | 5 | 5 | 5 |
| (G-1) | 300 | 300 | 300 | 300 | 300 | 300 | 300 | 300 |
| (H-1) | 0.10 | 0.15 | 0.20 | | | 0.10 | 0.15 | 0.20 |
| (H-2) | | | | 0.15 | | | | |
| (H-3) | | | | | 0.15 | | | |

TABLE 2

| Polymerizable | | | | | | | | |
|---|---|---|---|---|---|---|---|---|
| liquid crystal | | | | | | | | |
| composition | (9) | (10) | (11) | (12) | (13) | (14) | (15) | (16) |
| (A-1) | 40 | 40 | 10 | | | | | |
| (A-2) | 40 | 40 | 10 | 40 | | | | |
| (A-3) | 20 | 20 | | | | | | |
| (A-4) | | | | 10 | | | | |
| (A-5) | | | | 25 | 43 | 43 | 43 | 15 |
| (A-6) | | | | 25 | 43 | 43 | 43 | 45 |
| (A-8) | | | | | | | | 40 |
| (B-1) | | | 40 | | | | | |
| (B-2) | | | 40 | | | | | |
| (B-3) | | | | | 14 | 14 | 14 | |
| (E-1) | 0.1 | 0.1 | 0.1 | 0.1 | 0.1 | 0.1 | 0.1 | 0.1 |
| (F-1) | 5 | 5 | 5 | 5 | 3 | 3 | 3 | 3 |
| (G-1) | 300 | 300 | 300 | 300 | 300 | 300 | 300 | 300 |
| (H-1) | | | 0.15 | 0.15 | 0.05 | | | 0.05 |
| (H-2) | 0.15 | | | | | 0.05 | | |
| (H-3) | | 0.15 | | | | | 0.05 | |

TABLE 3

| Polymerizable | | | | | | | | |
|---|---|---|---|---|---|---|---|---|
| liquid crystal | | | | | | | | |
| composition | (17) | (18) | (19) | (20) | (21) | (22) | (23) | (24) |
| (A-1) | | | | | | 42 | 9 | |
| (A-2) | | 10 | 10 | | | 33 | 4 | |
| (A-3) | | 20 | 20 | 10 | 10 | | | 43 |
| (A-5) | 15 | 27.5 | 27.5 | 27.5 | 27.5 | | | |
| (A-6) | 45 | 27.5 | 27.5 | 27.5 | 27.5 | | | |
| (A-7) | | | | | | | | 34 |
| (A-8) | 40 | | | | | | | |
| (A-9) | | | | | | | 47 | |
| (B-1) | | | | 10 | 10 | | | |
| (B-2) | | | | 10 | 10 | 25 | 25 | |
| (B-3) | | 15 | 15 | 15 | 15 | | | |
| (B-4) | | | | | | | 15 | |
| (B-5) | | | | | | | | 23 |
| (E-1) | 0.1 | 0.1 | 0.1 | 0.1 | 0.1 | 0.1 | 0.1 | 0.1 |
| (F-1) | 3 | 3 | 3 | 3 | 3 | 5 | 5 | 3 |
| (G-1) | 300 | 300 | 300 | 300 | 300 | 300 | 300 | 300 |
| (H-1) | | 0.05 | | 0.05 | | 0.05 | 0.05 | 0.15 |
| (H-3) | 0.05 | | 0.05 | | 0.05 | | | |

TABLE 4

| Polymerizable | | | | | | |
|---|---|---|---|---|---|---|
| liquid crystal | | | | | | |
| composition | (25) | (26) | (C1) | (C2) | (C3) | (C4) |
| (A-1) | 20 | 35 | 30 | 30 | 30 | |
| (A-2) | | 35 | 30 | 30 | 30 | |
| (A-3) | 30 | | | | | |
| (A-5) | | | | | | 43 |
| (A-6) | | | | | | 43 |
| (B-1) | | | 15 | 15 | 15 | |
| (B-2) | | | 15 | 15 | 15 | |
| (B-3) | | | 10 | 10 | 10 | 14 |
| (B-7) | 30 | | | | | |
| (C-1) | 20 | | | | | |
| (C-2) | | 30 | | | | |
| (E-1) | 0.1 | 0.1 | 0.1 | 0.1 | 0.1 | 0.1 |
| (F-1) | 3 | 3 | 5 | 5 | 5 | 3 |
| (G-1) | 300 | 300 | 300 | 300 | 300 | 300 |
| (H-1) | 0.15 | 0.15 | | | | |
| (H-4) | | | 0.10 | 0.15 | | 0.10 |
| (H-5) | | | | | 0.50 | |

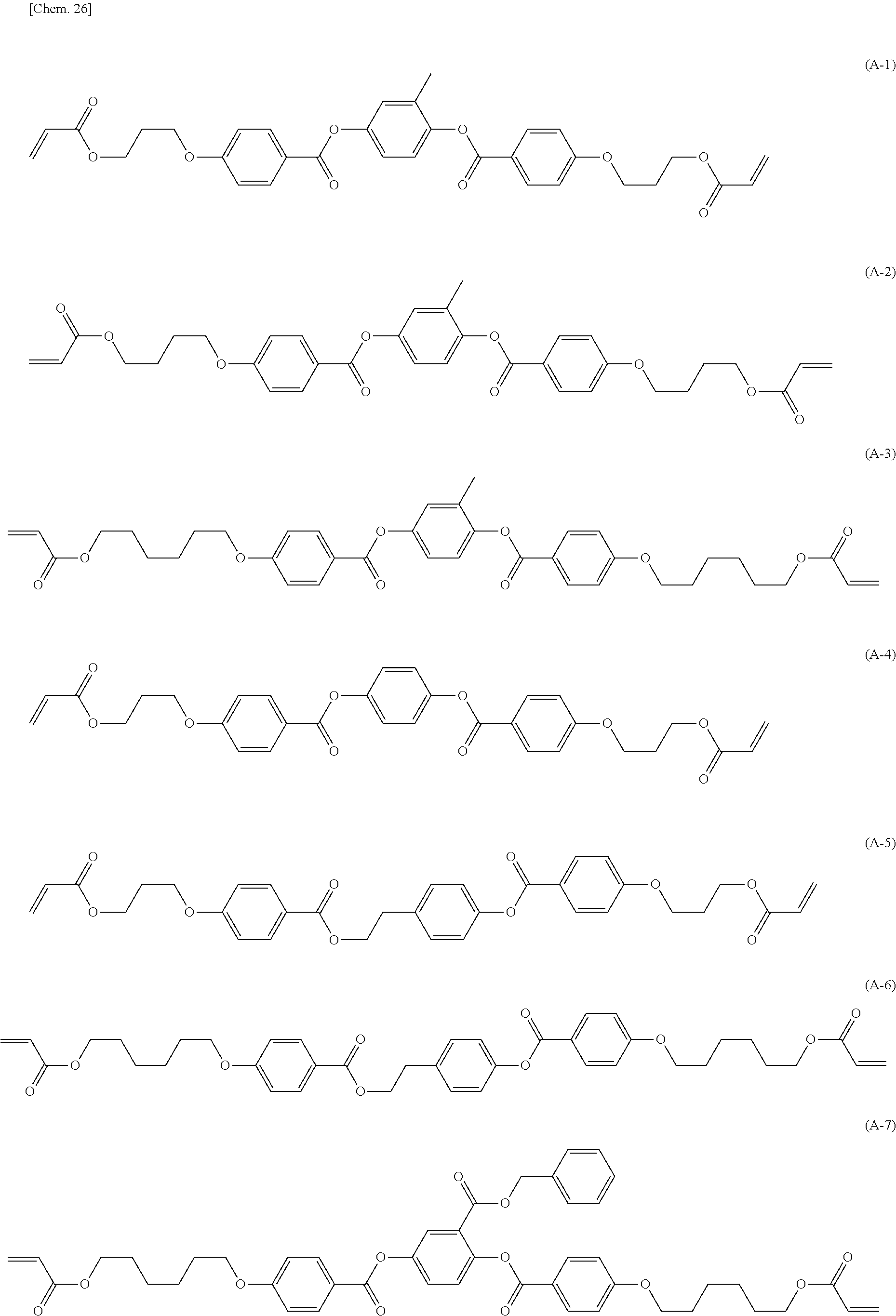

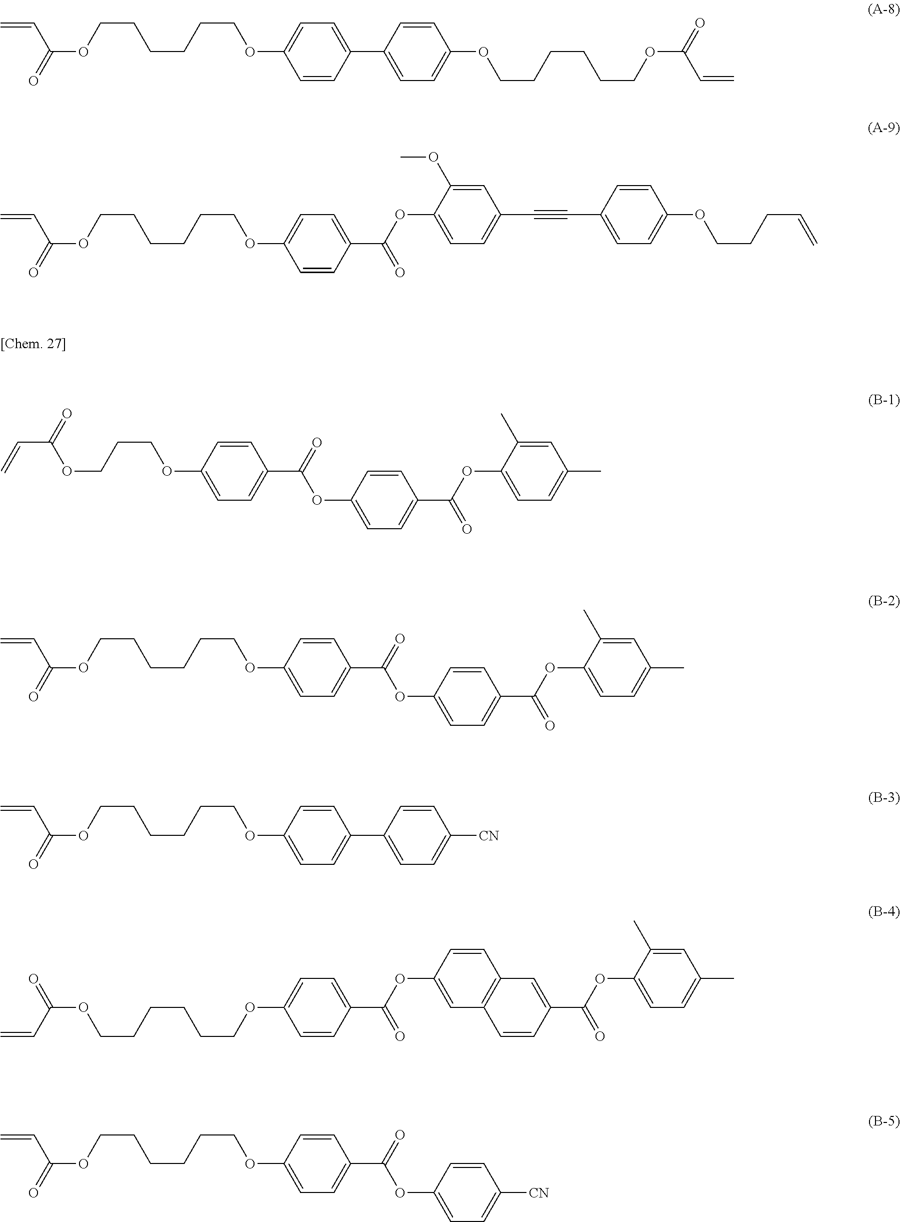

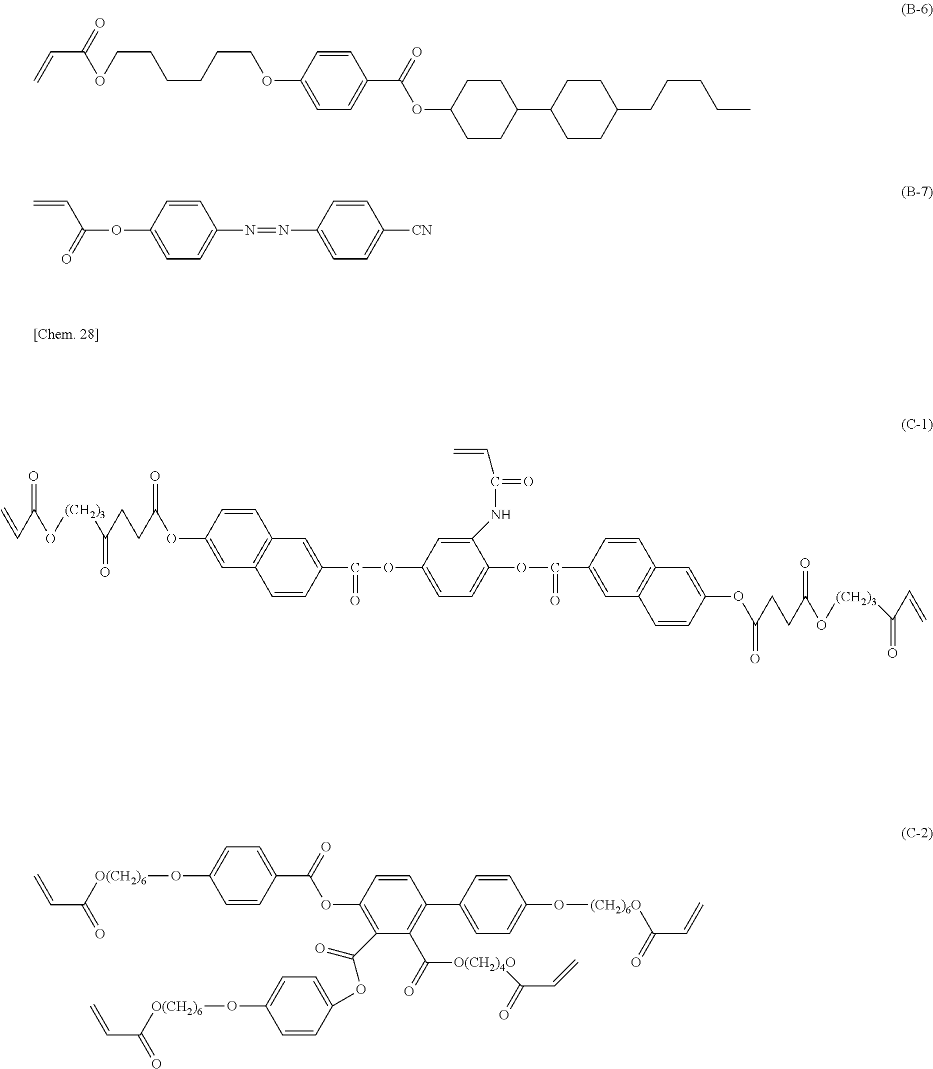

### Irgacure 907 (F-1)

Methyl isobutyl ketone (G-1)

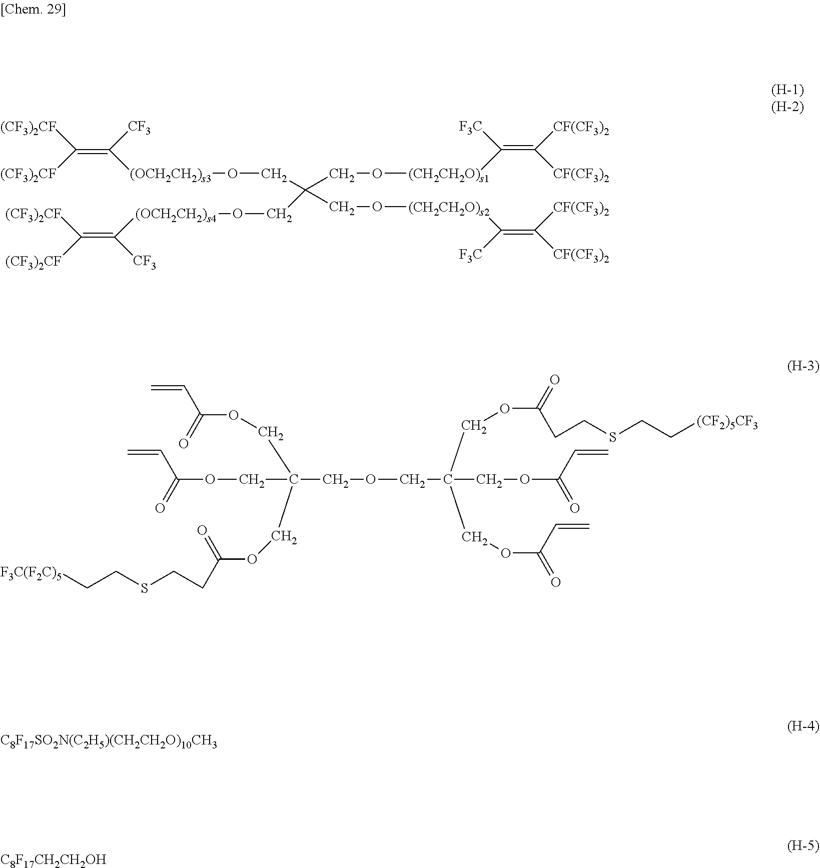

Compound (H-1): p1+p2+p3+p4=18
Compound (H-2): p1+p2+p3+p4=12

### Examples 2 to 12, Examples 24 to 26, and Comparative Examples 1 to 4

In the same manner as preparation of polymerizable liquid crystal composition (1) according to the present invention, polymerizable liquid crystal compositions (2) to (12) of examples 2 to 12, polymerizable liquid crystal compositions (24) to (26) of examples 24 to 26, and polymerizable liquid crystal compositions (C1) to (C4) of comparative examples 1 to 4 were obtained in accordance with the compositions shown in Tables 1 to 4.

(Evaluation of Leveling Properties)

Optically anisotropic bodies were produced in the same manner as example 1 except that polymerizable liquid crystal composition (1) according to the present invention was changed to polymerizable liquid crystal compositions (2) to (12) of examples 2 to 12, polymerizable liquid crystal compositions (24) to (26) of examples 24 to 26, and polymerizable liquid crystal compositions (C1) to (C4) of comparative examples 1 to 4. The resulting optically anisotropic bodies were positive A-plates. The manner of cissing of each of the resulting optically anisotropic bodies was visually observed in the same manner as example 1.

(Evaluation of Offset)

Whether offset of the surfactant in the polymerizable liquid crystal composition to film (B) occurred or not was visually observed in the same manner as example 1.

(Evaluation of Alignment Properties)

Optically anisotropic bodies were produced in the same manner as example 1 except that polymerizable liquid crystal composition (1) according to the present invention was changed to polymerizable liquid crystal compositions (2) to (12) of examples 2 to 12, polymerizable liquid crystal compositions (24) to (26) of examples 24 to 26, and polymerizable liquid crystal compositions (C1) to (C4) of comparative examples 1 to 4. The resulting optically anisotropic bodies were positive A-plates. The alignment properties of each of the resulting optically anisotropic bodies were observed visually and by a polarization microscope in the same manner as example 1.

### Examples 13 to 21

In the same manner as preparation of polymerizable liquid crystal composition (1) according to the present invention, polymerizable liquid crystal compositions (13) to (21) of examples 13 to 21 were obtained in accordance with the compositions shown in Tables 1 to 4.

(Evaluation of Leveling Properties)

Optically anisotropic bodies were produced in the same manner as example 1 except that polymerizable liquid crystal composition (1) according to the present invention was changed to polymerizable liquid crystal compositions (13) to (21) of examples 13 to 21 and the base material to be used was changed to COP film (c) or COP film (d) in which a silane coupling-based vertically aligned film was stacked. The resulting optically anisotropic bodies were positive C-plates. The manner of cissing of each of the resulting optically anisotropic bodies was visually observed in the same manner as example 1.

(Evaluation of Offset)

Whether offset of the surfactant in the polymerizable liquid crystal composition to film (B) occurred or not was visually observed in the same manner as example 1.

(Evaluation of Alignment Properties)

Optically anisotropic bodies were produced in the same manner as example 1 except that polymerizable liquid crystal composition (1) according to the present invention was changed to polymerizable liquid crystal compositions (13) to (21) of examples 13 to 21 and the base material to be used was changed to COP film (c) or COP film (d) in which a silane coupling-based vertically aligned film was stacked. The resulting optically anisotropic bodies were positive C-plates. The alignment properties of each of the resulting optically anisotropic bodies were observed visually and by a polarization microscope in the same manner as example 1.

### Examples 22 and 23

In the same manner as preparation of polymerizable liquid crystal composition (1) according to the present invention, polymerizable liquid crystal compositions (22) and (23) of examples 22 and 23 were obtained in accordance with the compositions shown in Tables 1 to 4.

(Evaluation of Leveling Properties)

Optically anisotropic bodies were produced in the same manner as example 1 except that polymerizable liquid crystal composition (1) according to the present invention was changed to polymerizable liquid crystal compositions (22) and (23) of examples 22 and 23 and the base material to be used was changed to TAC (triacetyl cellulose) film (b), which had been subjected to rubbing treatment. The resulting optically anisotropic bodies were negative C-plates. The manner of cissing of each of the resulting optically anisotropic bodies was visually observed in the same manner as example 1.

(Evaluation of Offset)

Whether offset of the surfactant in the polymerizable liquid crystal composition to film (B) occurred or not was visually observed in the same manner as example 1.

(Evaluation of Alignment Properties)

Optically anisotropic bodies were produced in the same manner as example 1 except that polymerizable liquid crystal composition (1) according to the present invention was changed to polymerizable liquid crystal compositions (22) and (23) of examples 22 and 23 and the base material to be used was changed to TAC (triacetyl cellulose) film (b), which had been subjected to rubbing treatment. The resulting optically anisotropic bodies were negative C-plates. The alignment properties of each of the resulting optically anisotropic bodies were observed visually and by a polarization microscope in the same manner as example 1.

The evaluation results of examples 1 to 26 and comparative examples 1 to 4 are shown in the following table.

TABLE 5

| | | Evaluation of | | | Evaluation of | |
|---|---|---|---|---|---|---|
| | | leveling | | | alignment | |
| | Polymerizable | properties | | Evaluation | properties | |
| | liquid crystal | Base | | result of | Base | |
| | composition | material | Result | offset | material | Result |
| Example 1 | (1) | (a) | ⊙ | ◯ | (b) | ⊙ |
| Example 2 | (2) | (a) | ⊙ | ⊙ | (b) | ⊙ |
| Example 3 | (3) | (a) | ◯ | ⊙ | (b) | ⊙ |
| Example 4 | (4) | (a) | ◯ | ⊙ | (b) | ⊙ |
| Example 5 | (5) | (a) | ⊙ | ◯ | (b) | ⊙ |
| Example 6 | (6) | (a) | ⊙ | ◯ | (b) | ⊙ |
| Example 7 | (7) | (a) | ⊙ | ⊙ | (b) | ⊙ |
| Example 8 | (8) | (a) | ◯ | ⊙ | (b) | ⊙ |
| Example 9 | (9) | (a) | ◯ | ⊙ | (b) | ⊙ |
| Example 10 | (10) | (a) | ⊙ | ◯ | (b) | ⊙ |
| Example 11 | (11) | (a) | ⊙ | ⊙ | (b) | ⊙ |
| Example 12 | (12) | (a) | ⊙ | ⊙ | (b) | ⊙ |
| Example 13 | (13) | (c) | ⊙ | ◯ | (c) | ⊙ |
| Example 14 | (14) | (c) | ⊙ | ◯ | (c) | ⊙ |
| Example 15 | (15) | (c) | ⊙ | ◯ | (c) | ⊙ |
| Example 16 | (16) | (c) | ⊙ | ◯ | (c) | ⊙ |
| Example 17 | (17) | (c) | ⊙ | ◯ | (c) | ⊙ |
| Example 18 | (18) | (d) | ⊙ | ◯ | (d) | ⊙ |
| Example 19 | (19) | (d) | ⊙ | ◯ | (d) | ⊙ |
| Example 20 | (20) | (d) | ⊙ | ◯ | (d) | ⊙ |
| Example 21 | (21) | (d) | ⊙ | ◯ | (d) | ⊙ |
| Example 22 | (22) | (b) | ⊙ | ◯ | (b) | ⊙ |
| Example 23 | (23) | (b) | ⊙ | ◯ | (b) | ⊙ |
| Example 24 | (24) | (a) | ⊙ | ⊙ | (b) | ⊙ |
| Example 25 | (25) | (a) | ⊙ | ⊙ | (b) | ⊙ |
| Example 26 | (26) | (a) | ⊙ | ⊙ | (b) | ⊙ |
| Comparative | (C1) | (a) | Δ | Δ | (b) | Δ |
| example 1 | | | | | | |
| Comparative | (C2) | (a) | X | ◯ | (b) | ◯ |
| example 2 | | | | | | |
| Comparative | (C3) | (a) | X | ◯ | (b) | ◯ |
| example 3 | | | | | | |
| Comparative | (C4) | (a) | Δ | Δ | (b) | ◯ |
| example 4 | | | | | | |

### Example 2753

Polymerizable compositions (27) to (53 of example 27 to 53 were produced under the same condition as the condition for preparing polymerizable composition (1) of example 1 except that the proportion of each of the compounds shown in the following tables was changed to each of the proportions shown in the following tables. Table 6 to Table 9 described below show specific compositions of polymerizable compositions (27) to (53) according to the present invention.

TABLE 6

| Polymerizable | | | | | | | |
|---|---|---|---|---|---|---|---|
| liquid crystal | | | | | | | |
| composition | (27) | (28) | (29) | (30) | (31) | (32) | (33) |
| (A-1) | 34 | 34 | | | 11 | | |
| (A-3) | 10 | 10 | 32 | 32 | 19 | | |
| (A-5) | | | | | | 15 | 15 |
| (A-6) | | | | | | 45 | 45 |
| (A-10) | | | | | | 40 | 40 |
| (B-5) | 28 | 28 | 28 | 28 | 26 | | |
| (B-9) | 28 | 28 | 12 | 12 | 27 | | |
| (B-10) | | | 28 | 28 | | | |
| (B-13) | | | | | 8.5 | | |
| (B-14) | | | | | 8.5 | | |
| (E-1) | 0.1 | 0.1 | 0.1 | 0.1 | 0.1 | 0.1 | 0.1 |
| (F-1) | 6 | 6 | 6 | 6 | | 3 | 3 |
| (F-2) | | | | | 1 | | |
| (G-1) | 300 | 300 | 300 | 300 | 300 | 300 | 300 |
| (H-1) | 0.20 | | 0.20 | | 0.20 | 0.05 | |
| (H-3) | | 0.20 | | 0.20 | | | 0.05 |

TABLE 7

| Polymerizable | | | | | | | |
|---|---|---|---|---|---|---|---|
| liquid crystal | | | | | | | |
| composition | (34) | (35) | (36) | (37) | (38) | (39) | (40) |
| (A-1) | | | 21 | 21 | 42 | 42 | |
| (A-2) | 15 | 15 | | | | | |
| (A-3) | 25 | 25 | 23 | 23 | | | |
| (A-5) | | | | | | | 50 |
| (A-6) | | | | | | | 50 |
| (B-1) | 15 | 15 | | | | | |
| (B-2) | 45 | 45 | | | | | |
| (B-5) | | | 21 | 21 | 10 | 10 | |
| (B-10) | | | 35 | 35 | 48 | 48 | |
| (E-1) | 0.1 | 0.1 | 0.1 | 0.1 | 0.1 | 0.1 | 0.1 |
| (F-1) | 3 | 3 | 6 | 6 | 4 | 4 | 3 |
| (G-1) | 300 | 300 | 300 | 300 | 300 | 300 | 300 |
| (H-1) | 0.05 | | 0.05 | | 0.05 | | 0.05 |
| (H-3) | | 0.05 | | 0.05 | | 0.05 | |

TABLE 8

| Polymerizable | | | | | | | |
|---|---|---|---|---|---|---|---|
| liquid crystal | | | | | | | |
| composition | (41) | (42) | (43) | (44) | (45) | (46) | (47) |
| (A-1) | | 30 | 30 | 15 | 15 | 42 | 9 |
| (A-2) | | | | | | 33 | 4 |
| (A-3) | | | | 3 | 3 | | |
| (A-5) | 20 | | | | | | |
| (A-6) | 50 | | | | | | |
| (A-9) | | | | | | | 47 |
| (B-2) | | | | | | 25 | 25 |
| (B-4) | | | | | | | 15 |
| (B-5) | | 30 | 30 | | | | |
| (B-8) | 30 | | | | | | |
| (B-10) | | 40 | 40 | 12 | 12 | | |
| (B-11) | | | | 70 | 70 | | |
| (D-1) | | | | | | 8 | |
| (D-2) | | | | | | | 5 |
| (D-3) | | | | 3 | 3 | | |
| (E-1) | 0.1 | 0.1 | 0.1 | 0.1 | 0.1 | 0.1 | 0.1 |
| (F-1) | 3 | 7 | 7 | 6 | 6 | 5 | 5 |
| (G-1) | 300 | 300 | 300 | 300 | 300 | 300 | 300 |
| (H-1) | 0.05 | 0.02 | | 0.10 | | 0.05 | 0.05 |
| (H-3) | | | 0.02 | | 0.10 | | |

TABLE 9

| Polymerizable | | | | | | |
|---|---|---|---|---|---|---|
| liquid crystal | | | | | | |
| composition | (48) | (49) | (50) | (51) | (52) | (53) |
| (A-1) | | | 57 | 57 | 47 | 47 |
| (A-3) | 21 | 21 | 13 | 13 | | |
| (B-5) | | | 9 | 9 | 3 | 3 |
| (B-9) | | | 21 | 21 | 8 | 8 |
| (B-10) | 8 | 8 | | | | |
| (B-12) | | | | | 31.5 | 31.5 |
| (D-4) | 5 | 5 | | | | |
| (D-5) | 66 | 66 | | | | |
| (D-6) | | | | | 10.5 | 10.5 |
| (E-1) | 0.1 | 0.1 | 0.1 | 0.1 | 0.1 | 0.1 |
| (F-3) | 2 | 2 | 2 | 2 | 4 | 4 |
| (G-1) | 300 | 300 | 300 | 300 | 300 | 300 |
| (H-1) | 0.20 | | 0.20 | | 0.20 | |
| (H-3) | | 0.20 | | 0.20 | | 0.20 |
| (I-1) | 2 | 2 | | | | |

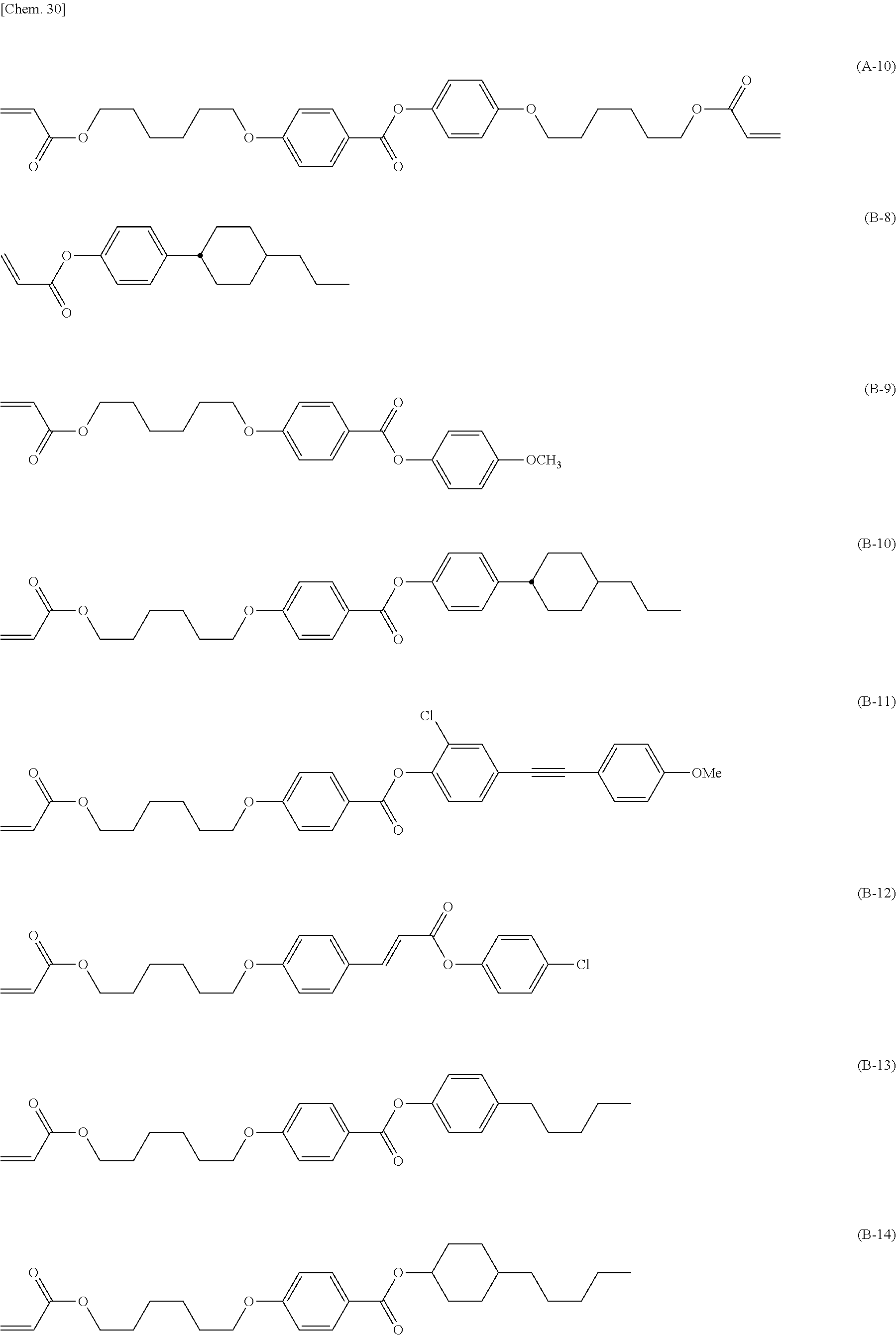

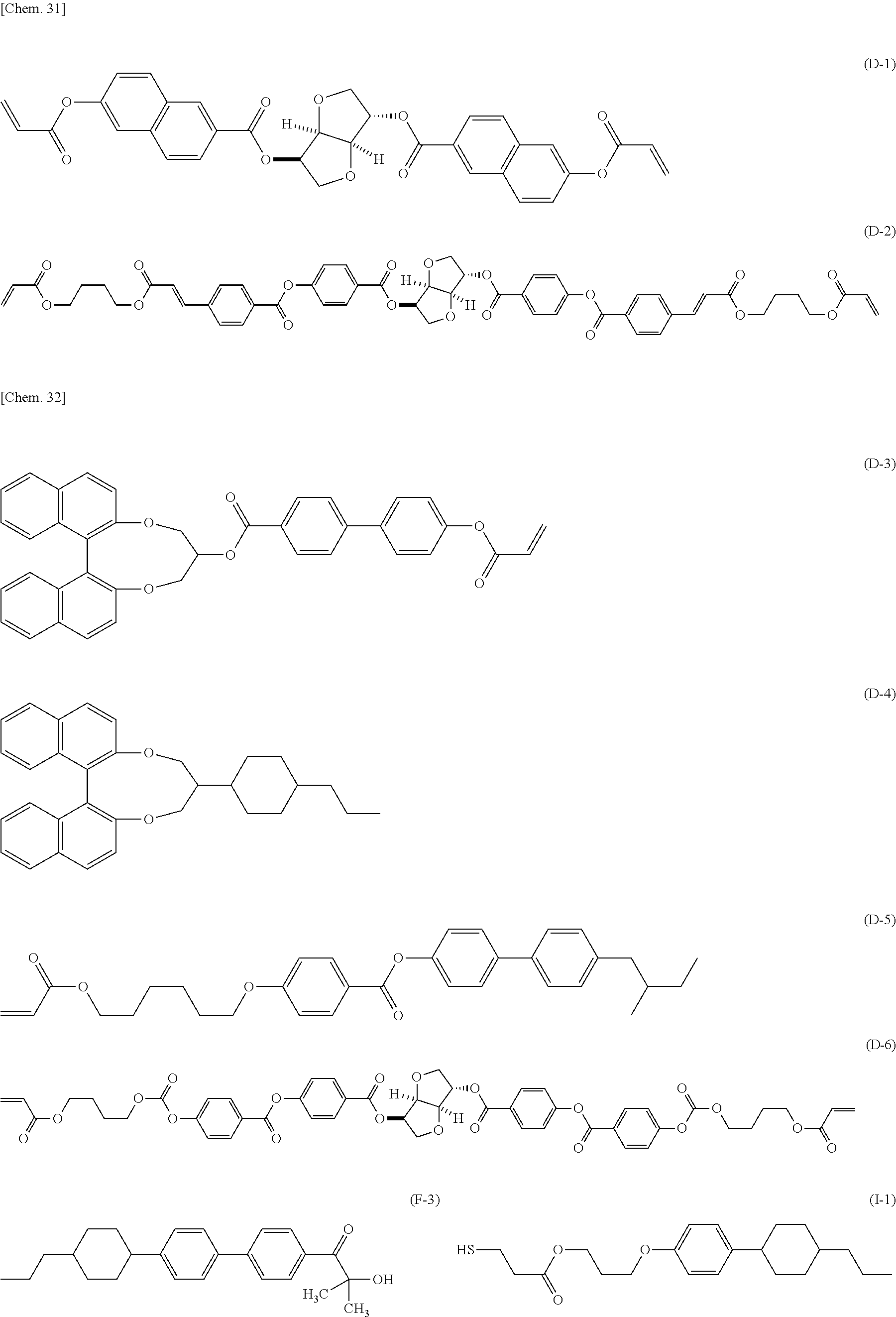

(Evaluation of Leveling Properties)

Optically anisotropic bodies that were positive A-plates were produced in the same manner as example 1 except that polymerizable liquid crystal composition (1) according to the present invention was changed to polymerizable liquid crystal compositions (27) to (31).

Optically anisotropic bodies that were positive C-plates were produced in the same manner as example 1 except that polymerizable liquid crystal composition (1) according to the present invention was changed to polymerizable liquid crystal compositions (32) to (39) and the base material to be used was changed to COP film (c) or COP film (d) in which a silane coupling-based vertically aligned film was stacked.

Optically anisotropic bodies that were positive O-plates were produced in the same manner as example 1 except that polymerizable liquid crystal composition (1) according to the present invention was changed to polymerizable liquid crystal compositions (40) to (43) and the base material to be used was changed to TAC (triacetyl cellulose) film (b), which had been subjected to rubbing treatment.

Optically anisotropic bodies that were negative C-plates were produced in the same manner as example 1 except that polymerizable liquid crystal composition (1) according to the present invention was changed to polymerizable liquid crystal compositions (44) to (47) and the base material to be used was changed to TAC (triacetyl cellulose) film (b), which had been subjected to rubbing treatment.

Optically anisotropic bodies that were biaxial plates were produced in the same manner as example 1 except that polymerizable liquid crystal composition (1) according to the present invention was changed to polymerizable liquid crystal compositions (48) to (53) and the base material to be used was changed to TAC (triacetyl cellulose) film (b), which had been subjected to rubbing treatment.

The manner of cissing of each of the resulting optically anisotropic bodies was visually observed in the same manner as example 1.

(Evaluation of Offset)

Whether offset of the surfactant in the polymerizable liquid crystal composition to film (B) occurred or not was visually observed in the same manner as example 1.

(Evaluation of Alignment Properties)

Optically anisotropic bodies that were positive A-plates were produced in the same manner as example 1 except that polymerizable liquid crystal composition (1) according to the present invention was changed to polymerizable liquid crystal compositions (27) to (31) of examples 27 to 31.

Optically anisotropic bodies that were positive C-plates were produced in the same manner as example 1 except that polymerizable liquid crystal composition (1) according to the present invention was changed to polymerizable liquid crystal compositions (32) to (39) of examples 32 and 39 and the base material to be used was changed to COP film (c) or COP film (d) in which a silane coupling-based vertically aligned film was stacked.

Optically anisotropic bodies that were positive 0-plates were produced in the same manner as example 1 except that polymerizable liquid crystal composition (1) according to the present invention was changed to polymerizable liquid crystal compositions (40) to (43) of examples 40 to 43.

Optically anisotropic bodies that were negative C-plates were produced in the same manner as example 1 except that polymerizable liquid crystal composition (1) according to the present invention was changed to polymerizable liquid crystal compositions (44) to (47) of examples 44 to 47.

Optically anisotropic bodies that were biaxial plates were produced in the same manner as example 1 except that polymerizable liquid crystal composition (1) according to the present invention was changed to polymerizable liquid crystal compositions (48) to (53) of examples 48 and 53.

The alignment properties of each of the resulting optically anisotropic bodies were observed visually and by a polarization microscope in the same manner as example 1. The evaluation results of examples 27 to 53 are shown in the following table.

TABLE 10

| | | Evaluation of | | | Evaluation of | |
|---|---|---|---|---|---|---|
| | | leveling | | Evaluation | alignment | |
| | Polymerizable | properties | | result of | properties | |
| | liquid crystal | Base | | offset | Base | |
| | composition | material | Result | properties | material | Result |
| Example 27 | (27) | (a) | ⊙ | ◯ | (b) | ⊙ |
| Example 28 | (28) | (a) | ⊙ | ◯ | (b) | ⊙ |
| Example 29 | (29) | (a) | ⊙ | ◯ | (b) | ⊙ |
| Example 30 | (30) | (a) | ⊙ | ◯ | (b) | ⊙ |
| Example 31 | (31) | (a) | ⊙ | ◯ | (b) | ⊙ |
| Example 32 | (32) | (c) | ⊙ | ◯ | (c) | ◯ |
| Example 33 | (33) | (c) | ⊙ | ◯ | (c) | ◯ |
| Example 34 | (34) | (d) | ⊙ | ⊙ | (d) | ⊙ |
| Example 35 | (35) | (d) | ⊙ | ⊙ | (d) | ⊙ |
| Example 36 | (36) | (d) | ⊙ | ◯ | (d) | ◯ |
| Example 37 | (37) | (d) | ⊙ | ◯ | (d) | ◯ |
| Example 38 | (38) | (d) | ⊙ | ◯ | (d) | ◯ |
| Example 39 | (39) | (d) | ⊙ | ◯ | (d) | ◯ |
| Example 40 | (40) | (b) | ⊙ | ◯ | (b) | ◯ |
| Example 41 | (41) | (b) | ⊙ | ⊙ | (b) | ⊙ |
| Example 42 | (42) | (b) | ⊙ | ◯ | (b) | ⊙ |
| Example 43 | (43) | (b) | ⊙ | ◯ | (b) | ⊙ |
| Example 44 | (44) | (b) | ⊙ | ◯ | (b) | ◯ |
| Example 45 | (45) | (b) | ⊙ | ◯ | (b) | ◯ |
| Example 46 | (46) | (b) | ⊙ | ◯ | (b) | ⊙ |
| Example 47 | (47) | (b) | ⊙ | ◯ | (b) | ⊙ |
| Example 48 | (48) | (b) | ⊙ | ◯ | (b) | ⊙ |
| Example 49 | (49) | (b) | ⊙ | ◯ | (b) | ⊙ |
| Example 50 | (50) | (b) | ⊙ | ◯ | (b) | ⊙ |
| Example 51 | (51) | (b) | ⊙ | ◯ | (b) | ⊙ |
| Example 52 | (52) | (b) | ⊙ | ◯ | (b) | ⊙ |
| Example 53 | (53) | (b) | ⊙ | ◯ | (b) | ⊙ |

As described above, regarding the polymerizable liquid crystal compositions (examples 1 to 53) including the surfactants denoted by formula (H-1) to formula (H-3), it can be said that all the evaluation of the leveling properties, the evaluation of the offset, and the test results of the alignment properties were good and the productivity was excellent. Among them, in particular, regarding the polymerizable liquid crystal compositions including fluorosurfactants having a pentaerythritol skeleton and an ethylene oxide group, the evaluation of the leveling properties, the evaluation of the offset, and the test results of the alignment properties were very good. On the other hand, according to the results of comparative examples 1 to 4, in the case where a monomolecular fluorosurfactant that had neither a pentaerythritol skeleton nor dipentaerythritol skeleton was used, one of the evaluation of the leveling properties, the evaluation of the offset, and the test result of the alignment properties was poor. Therefore, the results were inferior to the results of the polymerizable liquid crystal compositions according to the present invention.

1. A polymerizable liquid crystal composition comprising at least one polymerizable compound denoted by a general formula (I) 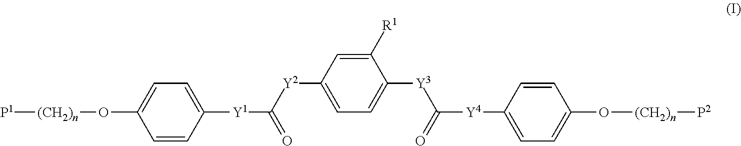
(n represents an integer of 1 to 10, each of P¹ and P² represents an acryloyl group, a methacryloyl group, a vinyl ether group, an aliphatic epoxy group, or an alicyclic epoxy group, each of Y¹, Y², Y³, and Y⁴ represents a single bond, —O—, —CH₂—, —CH₂CH₂—, —OCH₂CH₂—, or —CH₂CH₂O—, and R¹ represents a hydrogen atom, a methyl group, an ethyl group, a methoxy group, an ethoxy group, or —COO—CH₂—C₆H₅) and at least one fluorosurfactant selected from the group consisting of compounds having a pentaerythritol skeleton or a dipentaerythritol skeleton.

2. The polymerizable liquid crystal composition according to claim 1 comprising, as the compound having the pentaerythritol skeleton, at least one compound selected from the group consisting of compounds denoted by a general formula (III-1) 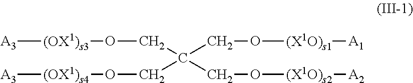
(in the formula, X¹ represents an alkylene group, s1 represents a numerical value of 1 to 80, each of s2 to s4 represents a numerical value of 0 to 79, s1+s2+s3+s4 represents a numerical value of 4 to 80, A₁ represents a fluoroalkyl group or a fluoroalkenyl group, and each of A₂ to A₄ represents a hydrogen atom, an acryloyl group, a methacryloyl group, a fluoroalkyl group, or a fluoroalkenyl group).

3. The polymerizable liquid crystal composition according to claim 1 comprising, as the compound having a dipentaerythritol skeleton, at least one compound selected from the group consisting of compounds denoted by a general formula (III-2) 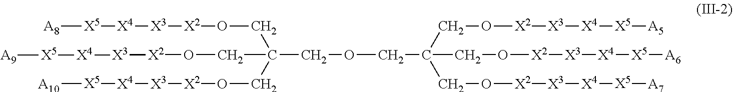
(in the formula, each of X², X³, X⁴, and X⁵ represents a single bond, —O—, —S—, —CO—, an alkyl group having a carbon atom number of 1 to 4, or an oxyalkylene group, A₅ represents a fluoroalkyl group or a fluoroalkenyl group, and each of A₆ to A₁₀ represents a hydrogen atom, an acryloyl group, a methacryloyl group, a fluoroalkyl group, or a fluoroalkenyl group).

4. The polymerizable liquid crystal composition according to claim 1 comprising, as the polymerizable compound denoted by the general formula (I), at least one polymerizable compound selected from the group consisting of compounds denoted by a general formula (I-1) 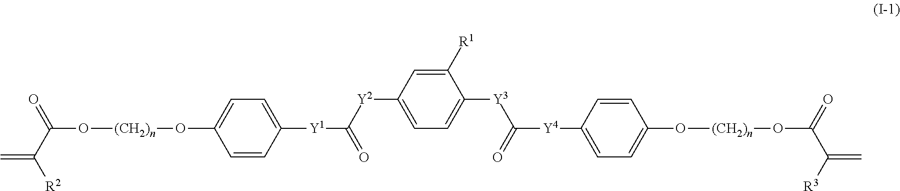
(n represents an integer of 1 to 10, each of Y¹, Y², Y³, and Y⁴ represents a single bond, —O—, —CH₂—, —CH₂CH₂—, —OCH₂CH₂—, or —CH₂CH₂O—, R¹ represents a hydrogen atom, a methyl group, an ethyl group, a methoxy group, an ethoxy group, or —COO—CH₂—C₆H₅, and each of R² and R³ represents a hydrogen atom or a methyl group).

5. The polymerizable liquid crystal composition according to claim 4 comprising, as the polymerizable compound denoted by the general formula (I-1), at least one polymerizable compound selected from the group consisting of compounds denoted by a formula (I-1-1) to a formula (I-1-7).

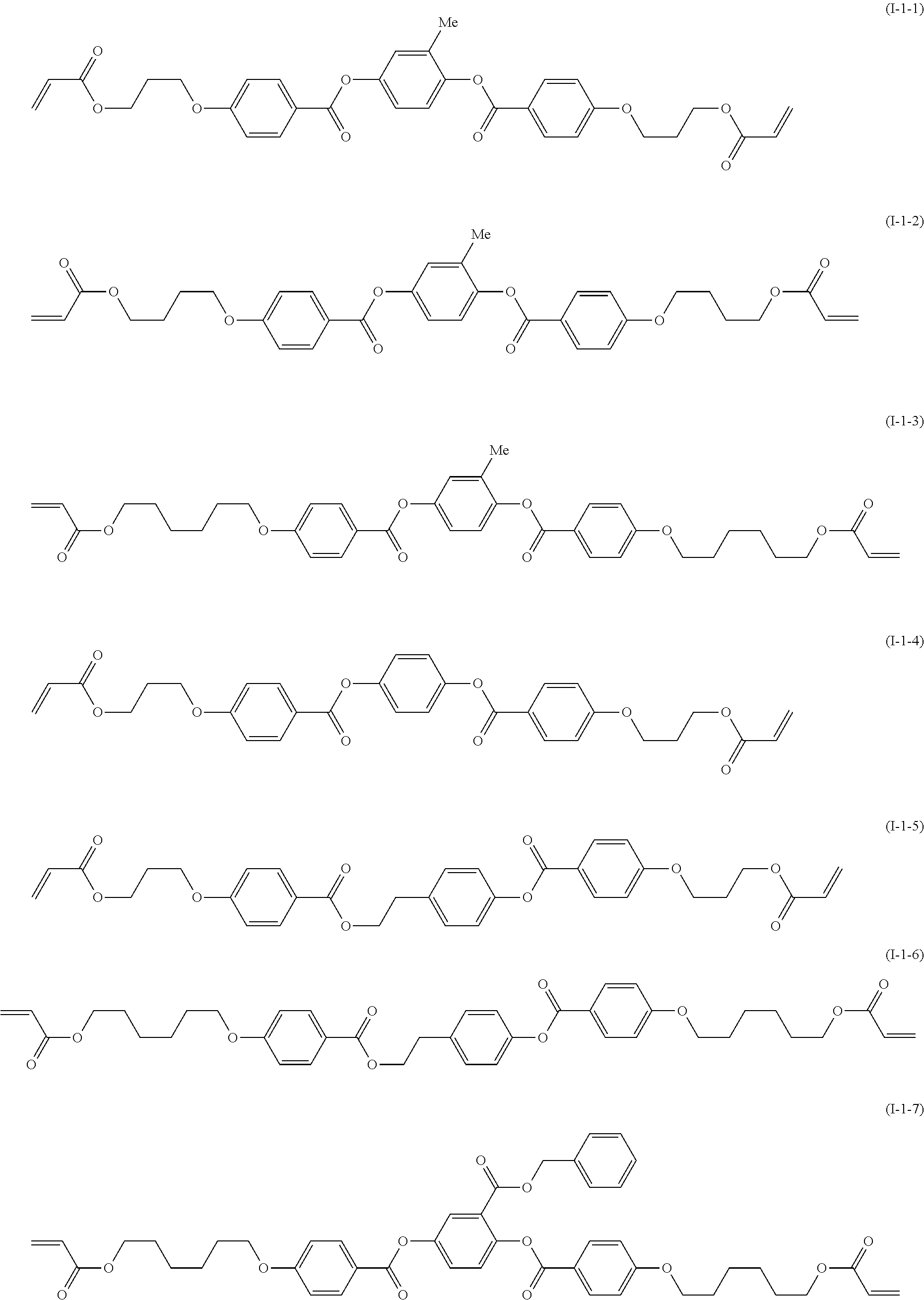

6. An optically anisotropic body produced by using the polymerizable liquid crystal composition according to claim 1.

7. A phase difference film produced by using the polymerizable liquid crystal composition according to claim 1.

8. An antireflection film produced by using the polymerizable liquid crystal composition according to claim 1.

9. A liquid crystal display element produced by using the polymerizable liquid crystal composition according to claim 1.
